(19) United States
(12) Patent Application Publication
(10) Pub. No.: US 2004/0204925 A1
(43) Pub. Date: Oct. 14, 2004

(54) Method for analyzing data to identify network motifs

(76) Inventors: Uri Alon, Tel Aviv (IL); Shalev Itzkovitz, Tel Aviv (IL); Reuven Levitt, Tel Aviv (IL); Nadav Kashtan, Tel Aviv (IL); Ron Milo, Rehovot (IL)

Correspondence Address: G.E. EHRLICH (1995) LTD., SUITE 207, 2001 JEFFERSON DAVIS HIGHWAY, ARLINGTON, VA, 22202, US

(21) Appl. No.: 10/746,277

(22) Filed: Dec. 29, 2003

Related U.S. Application Data
(63) Continuation-in-part of application No. PCT/IL03/00053, filed on Jan. 22, 2003.
(60) Provisional application No. 60/420,730, filed on Oct. 24, 2002.
(60) Provisional application No. 60/349,365, filed on Jan. 22, 2002.

(51) Int. Cl. G06F 17/10; G06F 7/60

(52) U.S. Cl. 703/2; 715/538

(57) ABSTRACT

A method for analyzing data, such as biological data for example, for identifying one or more network motifs, or recurring patterns of relationships and/or behavioral connections between the components of a complex system. The method of the present invention is optionally and preferably applied to biological systems, such as gene regulatory systems for example.

This is a Continuation in Part Application (CIP) of PCT Application No. PCT/IL03/00053, filed Jan. 22, 2003, which claims priority from U.S. Provisional Application No. 60/420,730, filed Oct. 24, 2002, and from U.S. Provisional Application No. 60/349,365, filed Jan. 22, 2002. All of these applications are hereby incorporated by reference as if fully set forth herein.

### FIELD OF THE INVENTION

The present invention is of a method for analyzing data for identifying at least one motif or underlying structural design, and in particular, for such a method in which the motif is identified according to a pattern of a plurality of interconnections in a network.

### BACKGROUND OF THE INVENTION

Many different types of complex networks are currently being studied, in many different scientific fields. These networks can be found in the fields of biology, electronics and economics, among others. However, all of these different types of networks share the property of being sufficiently complex that analysis of such networks is quite difficult.

As one example, gene regulation networks are complex, and thus new concepts will be required to understand them on the systems level¹⁻⁸. One important type of characterization of complex objects is a motif defined as a recurring structural design. Motifs are extremely useful concepts in understanding DNA sequences and protein structures⁹.

Currently, motifs are not being used to study large interconnected systems, such as gene regulatory systems and/or other types of biological systems. Such systems are characterized by their complexity, in terms of the number of components and/or the connections between these components. This complexity increases the difficulty in studying and analyzing the behavior of the system. For example, a combinatorial explosion may occur if the number of components and/or connections reaches a particular level. Additionally or alternatively, uncertainty or lack of knowledge concerning the behavior of one or more components, or concerning the relationship between components, also increases the difficulty inherent in analyzing such large, complex systems.

However, some attempts have been made to reduce the size of a network, by finding recurring building blocks in such networks, and removing those parts of the graph. The frequency at which such a building block must appear is not defined, and very often these attempts were highly error prone, mainly due to technical difficulties such as computation time.

For example, the SUBDUE Knowledge Discovery System developed in the University of Texas in Arlington (http://cygnus.uta.edu/subdue/), is directed at changing a complex graph in order to find a graph having a shorter length of data, when represented in bits. This is done by considering all sub-graphs of the network, and calculating the data length when each such sub-graph is replaced by a single node representing the sub-graph, disregarding the different node types within the sub-graph. As the process in exponential in computation time, and therefore computationally intractable, the algorithm used by SUBDUE is as an inexact search for a smaller representation of the graph. The inexact search finds sub-graphs that can be replaced to reduce the bit representation of the graph, but are distorted (e.g. have errors). If such an implementation is used a threshold parameter for the allowed distortion must be given.

### SUMMARY OF THE INVENTION

The background art does not teach or suggest a method for analyzing large, complex systems as overall systems. The background art also does not teach or suggest such a method which can handle uncertainty and/or lack of knowledge concerning the behavior of one or more components of the system. The background art also does not teach or suggest such a method which can handle uncertainty and/or lack of knowledge concerning the relationship between components.

The present invention overcomes these deficiencies of the background art by enabling a new kind of motif to be identified through the analysis of data, on the level of complex networks. The method is suitable for any network which is stateful and can be represented in a graph, including, but not limited to, networks involved in the regulation of biological activity, ecological food webs¹⁰, power grids, telecommunications networks, computer networks, compilers, traffic networks, organizational charts, electronic circuits, the stock market, economic relations between companies, and any product of human engineering. Hereinafter, these motifs are also referred to as “network motifs”. Such “network motifs” are patterns of interconnections that recur in different parts of the network, and preferably are found in the network in significantly higher numbers than they are found in randomized networks with the same or similar overall characteristics.

The method of the present invention can as an example optionally be used for the analysis of biological networks, such as neuronal networks¹¹, or gene regulation networks¹, particularly those involved in the regulation of transcription. Neuronal networks orchestrate all nerve signals to the different parts of the body, yet little is known or understood about the architecture and structure of their network connections. Similarly, transcriptional regulation networks in cells orchestrate gene expression, but little is known about the general features of their architecture¹⁻⁷. In addition, the present method can optionally be used for analysis of many other complex networks, such as the mentioned above, although little may be known as to the connections between the components in the network, and the specific features of these components.

The method of the present invention enables such networks to be decomposed into basic building blocks, by defining “network motifs”, patterns of interconnections that recur in many different parts of a network.

In different types of networks, distinct network motifs are found, thus defining generic classes of networks. This may also enable one to find similarities or homologies¹² between networks according to the network motifs appearing in each network. Many of the complex networks that appear in nature, and some man-made networks have been shown to share global statistical features⁷. These include the ‘small world’ property¹³⁻¹⁴ of short paths between any two nodes and highly clustered connections. In addition, in many networks there are a few nodes with much higher than average connectivity, and the connectivity distributions often show power-law-like tails⁶⁻¹⁵ (scale-free networks). In order to go beyond these global features an understanding of the basic structural elements particular to each class of networks is required¹⁶. The present invention provides a method for detecting such network motifs.

The method of the present invention is optionally and preferably used to detect at least a portion of the system under analysis that is operating at a lower efficiency than at least a second portion of the system. This may optionally be performed by detecting specific network motifs, such as a “fan-out” for example, in which many nodes are connected from a single node of the system, which may be indicative of a bottleneck, for example. The nature of the lowered efficiency may differ between systems.

Another example of a method for detecting an inefficient part of a system or even an example of an overall inefficient system is to compare the network motifs found in two exemplary systems, a first of which is considered to operate efficiently, and a second of which is not.

The present invention is particularly useful for systems that feature a plurality of dynamic processes, such that analyzing the system includes analyzing the dynamic processes.

Additionally, an algorithm based on the use of network motifs is shown, which can create a coarse-grain, simpler version of a complex network. Generally, the “coarse graining” method according to the present invention analyzes the network to obtain a set of a plurality of simpler sub-components. The set preferably contains a small number of such sub-components, relative to the size and complexity of the network as a whole, as sets with fewer components may potentially provide greater ease of understanding of the network. This set preferably acts as a “dictionary” for understanding the functionality and structure of the network, and enables a complex network to be reduced to a group of simpler structures. The relationship between these structures and their place in the network enables such a complex network to be more easily analyzed and understood.

According to the present optional, illustrative example, the set comprises a small dictionary of simple sub-graph types, which are used to analyze and understand the function of the network in terms of recurring building blocks. This “coarse grained” analysis preferably examines networks at a lower level of structure, as described in greater detail below.

The multi-level “coarse graining” process of the present invention, preferably uses any type of combinatorial optimization technique. The process preferably uses a minimization function with such a technique, such as a simulated annealing algorithm for example, as well as the network motifs found by the application of the method of the present invention to the network. The method can optionally and preferably be applied to electronic circuits and to protein signaling pathways.

Any of the methods described herein may optionally be implemented as a computer software program, as hardware, as firmware, or as a combination thereof.

### BRIEF DESCRIPTION OF THE DRAWINGS

The invention is herein described, by way of example only, with reference to the accompanying drawings, wherein:

FIG. 1 is a flow chart of an exemplary method according to the present invention;

FIG. 2A shows examples of interactions represented by directed edges between nodes in the networks used for the present study. These networks go from the scale of biomolecules (transcription factor protein X binds regulatory DNA regions of a gene to regulate the production rate of protein Y), through cells (neuron X is synaptically connected to neuron Y), to organisms (X feeds on Y);

FIG. 2B shows examples of all 13 types of 3-node connected subgraphs;

FIG. 3 shows a schematic view of network motif detection. Network motifs are patterns that recur much more frequently in the real network (FIG. 3A) than in an ensemble of randomized networks (FIG. 3B). Each node in the randomized networks has the same number of incoming and outgoing edges as the corresponding node in the real network. Red dashed lines: edges that participate in the feedforward loop motif, which occurs 5 times in the real network;

FIG. 4 is a representation of a gene transcriptional network as a directed graph;

FIG. 5. Network motifs found in the E. coli transcriptional regulation network;

FIG. 5A shows an example of a motif, termed ‘fan-out’, defined by a set of operons that are controlled by a single transcription factor (TF), detected according to the method of the present invention;

FIG. 5B shows a particular example of the “fan-out” motif for the arginine biosynthesis pathway;

FIG. 5C shows an example of a second motif, termed ‘gate array’, which is a layer of overlapping interactions between operons and a group of input TFs, detected according to the method of the present invention;

FIG. 5D shows a particular example of this second motif for the set of operons regulated by RpoS upon entry into stationary phase;

FIG. 5E shows an example of a third motif, termed ‘feedforward loop’, defined by a transcription factor X that regulates a second transcription factor Y, such that both X and Y jointly regulate an operon Z, detected according to the method of the present invention;

FIG. 5F shows a particular example of this third motif for the L-arabinose utilization system;

FIG. 6 shows the concentration, C, of the feedforward loop motif in real and randomized sub-networks of the E. coli transcription network(11). C is the number of appearances of the motif divided by the total number of appearances of all connected 3-node subgraphs (FIG. 2b). Sub-networks of size S were generated by choosing a node at random and adding to it nodes connected by an incoming or outgoing edge, until S nodes are obtained, and then including all the edges between these S nodes present in the full network. Each of the sub-networks was randomized (the randomized networks used for detecting 3-node motifs preserve the numbers of incoming, outgoing and double edges with both incoming and outgoing arrows for each node. The randomized networks used for detecting 4-node motifs preserve the above characteristics as well as the numbers of all thirteen 3-node subgraphs as in the real network) (shown are mean and SD of 400 sub-networks of each size);

FIG. 7 shows the network motifs found in the two gene-regulation, one neuron connectivity and seven food web networks using the method of the present invention;

FIG. 8 shows a representation of the entire known E. coli transcriptional network, in a compact, modular form, according to the present invention, using network motifs;

FIG. 9A shows a feedforward loop (FFL) that can be used as a ‘persistence detector’ circuit with an AND-like gate controlling the output node Z;

FIG. 9B displays a simple regulation (SR) circuit, in which one operon encodes for a TF that regulates another gene or operon directly;

FIG. 9C presents the response of FFL and SR circuits to a short and a long pulse-like stimuli;

FIG. 10 shows network motifs found in biological and technological networks. The number of nodes and edges for each network are shown. For each motif, the number of appearances in the real network (Nreal) and in the randomized networks (Nrand±SD, all values rounded) is shown. The P-value of all motifs is P<0.01 as determined by comparison to 1000 randomized networks (100 in the case of the World-Wide Web). As a qualitative measure of statistical significance, the Z-score=(Nreal−Nrand)/SD is shown. NS—not significant. The networks are: Transcription interactions between regulatory proteins and genes in the bacterium E. coli (S. Shen-Orr, R. Milo, S. Mangan, U. Alon, Nat Genet 31, 64-8 (2002)) and the yeast S. cerevisae (M. C. Costanzo et al., Nucleic Acids Res 29, 75-9. (2001)); Synaptic connections between neurons in C. elegans, including neurons connected by at least 5 synapses (J. White, E. Southgate, J. Thomson, S. Brenner, Phil. Trans. Roy. Soc. London Ser. B 314 (1986)); Trophic interactions in ecological food webs (R. Williams, N. Martinez, Nature 404, 180-183 (2000)), representing pelagic and benthic species (Little Rock lake), bird, fishes, invertebrates (Ythan Estuary), primarily larger fishes (Chesapeake Bay), lizards (St. Martin Island), primarily invertebrates (Skipwith pond), pelagic lake species (Bridge Brook Lake) and diverse desert taxa (Coachella Valley); Electronic sequential logic circuits parsed from the ISCAS89 benchmark set(7A, 25A), where nodes represent logic gates and flip-flops (presented are all 5 partial scans of forward-logic chips and 3 digital fractional multipliers in the benchmark set); World-Wide Web hyperlinks between web pages in a single domain (A. L. Barabasi, R. Albert, Science 286, 509-12. (1999)) (only 3-node motifs are shown).

FIG. 11 presents the classes of nodes and ports in a sub graph used as an SIU for an exemplary use of the present invention;

FIG. 11A shows a sub-graph with no mixed nodes;

FIG. 11B shows a sub-graph with a mixed node;

FIG. 12 is a flow chart of the stages of an exemplary simulated annealing algorithm;

FIG. 13 presents reverse-engineering of an electronic circuit, according to an exemplary method of the present invention;

FIG. 13A shows the transistor level map for this circuit, in which nodes are junctions between transistors and directed edges represent wire connections;

FIG. 13B shows the SIUs found in the different coarse-graining levels of the electronic circuit;

FIG. 13C shows four different levels of representation of the circuit, after coarse-graining on multiple levels;

FIG. 14 shows SIU candidates at transistor level in the coarse-graining of an electronic circuit, according to an exemplary method of the present invention;

FIG. 15 displays coarse-graining scores for the chosen SIU set displayed in FIG. 14, as a function of optimization parameters used by the present invention;

FIG. 15A presents the score of SIU set 1 of FIG. 14, which is optimal for a large range of parameters;

FIG. 15B presents a phase space plot of the optimal coarse graining score;

FIG. 16A shows a representation of a human signal transduction pathway network as a directed graph;

FIG. 16B shows the SIUs found in the network of FIG. 16A;

FIG. 16C displays a coarse grained version of the network of FIG. 16A;

FIG. 16D presents the three signaling channels included in the network, in a coarse grained form; and

FIG. 16E shows the motifs found in the two levels of coarse-graining of the network.

### DESCRIPTION OF THE PREFERRED EMBODIMENTS

The present invention is of a method for analyzing data, such as biological data for example, for identifying one or more network motifs, or recurring patterns of relationships and/or behavioral connections between the components of a is complex system. The method of the present invention can optionally be applied to biological systems, such as gene regulatory systems or neuronal network for example. Additionally the method of the present invention can optionally be used for analysis of many other complex non-biological networks, such as computer networks, telecommunications networks, or electronic circuits for example.

The present invention optionally and preferably provides a method for analyzing a system which is capable of being represented as a plurality of nodes connected by edges to form a graph. The method preferably includes analyzing the graph to form a plurality of sub-graphs, each sub-graph containing a plurality of nodes connected by at least one edge; and analyzing the plurality of sub-graphs to detect a type of sub-graph occurring at a threshold frequency in the graph, such that this type of sub-graph forms a motif of the system.

Optionally and more preferably, the process of analyzing the plurality of sub-graphs further includes constructing a randomized graph; and comparing a frequency of appearance of the type of sub-graph in the randomized graph with a frequency of appearance of the type of sub-graph in the graph. If a difference between the frequency of appearance of the type of sub-graph in the randomized graph, as opposed to the graph of the actual network, is significant, and more preferably statistically significant, the motif is formed with the type of sub-graph.

Preferably, the randomized graph has at least one feature similar to the network graph. More preferably, a plurality of characteristics of the nodes of the randomized graph is identical to these characteristics for the network graph.

According to preferred embodiments of the present invention, the method is performed in two stages. In a first stage, a connectivity matrix which represents the components of the system to be analyzed, and the relationships between these components thereof, is constructed. An element (i,j)=1 if a first component i is directly connected in the network to a second component j. Otherwise, the element is equal to zero. For example, for a gene transcription regulatory network, an element (i,j)=1 if operon j encodes for a TF that transcriptionally regulates operon i and is equal to zero otherwise. Next, n×n submatrices of this matrix are scanned, generated by choosing n nodes that lie in a connected graph. Submatrices may optionally and preferably be enumerated efficiently by recursively searching for nonzero elements (i,j), then scanning row i and column j for non-zero elements. A search may also optionally be performed for identical rows of the matrix in order to detect fan-outs. A “fan-out” occurs when a plurality of components of the network or system are related to a single component.

In the next stage, one or more groups (or “gate arrays”, also termed dense overlapping regions) of a plurality of components of the system are optionally located, represented as elements of the connectivity matrix. The group is optionally and preferably characterized according to a distance between the members of the group, in which the distance represents at least one characteristic of the nature of the relationship between group members. In order to locate each group, a distance measure is optionally and more preferably used to determine this distance. This distance measure is most preferably selected according to the type of system or network being analyzed.

As mentioned above, the matrix is preferably scanned for all possible n-node circuits, and the number of occurrences of each type of circuit is recorded. Each network contains numerous types of n-node circuits. To focus on circuits that are likely to be important, the real network is compared to suitably randomized networks¹⁸, and circuits that appear in the real network at significantly higher numbers than in the randomized networks are selected. The randomized networks have precisely the same single-node characteristics as the real network: Each node in the randomized networks has the same number of incoming and outgoing connections as the corresponding node in the real network. The comparison to this randomized ensemble accounts for patterns that appear only because of the single-node characteristics of the network (for example, the presence of highly connected nodes). A statistical significance is assigned to each circuit by comparing the number of times it appears in the real and randomized networks. To avoid assigning high significance to a circuit only due to the fact that it includes a highly significant sub-circuit, the appearance number of each circuit is normalized by the probability of occurrence of all of its sub-circuits. Therefore the effective number of appearances of an n-node circuit A is preferably defined in equation 1 as

N_{eff}(A)=Nᵣₑₐₗ(A) Π_{B} N_{rand}(B)Nᵣₑₐₗ(B) (1)

where the product is over all circuits B which are connected (n−1)-node subcircuits of A, Nᵣₑₐₗ is the number of times a circuit appears in the real network and N_{rand} is the average number of times it appears in a randomized network. A second method according to the present invention is also described below with regard to Example 1.

The network motifs are preferably motifs that satisfy two conditions. First they appear at least U times in the real network with completely different sets of nodes, and second the probability P that they appear in a randomized network an equal or greater number of times than the normalized value calculated is lower than a cutoff value.

Although the graph is preferably analyzed by scanning all nodes in an exhaustive search, alternatively, at least a portion of the nodes are scanned by sampling the connectivity matrix to detect the sub-graphs.

According to preferred embodiments of the present invention, a plurality of connectivity matrices is constructed, wherein each connectivity matrix represents a different discrete value in time for at least one edge between a plurality of nodes of the graph.

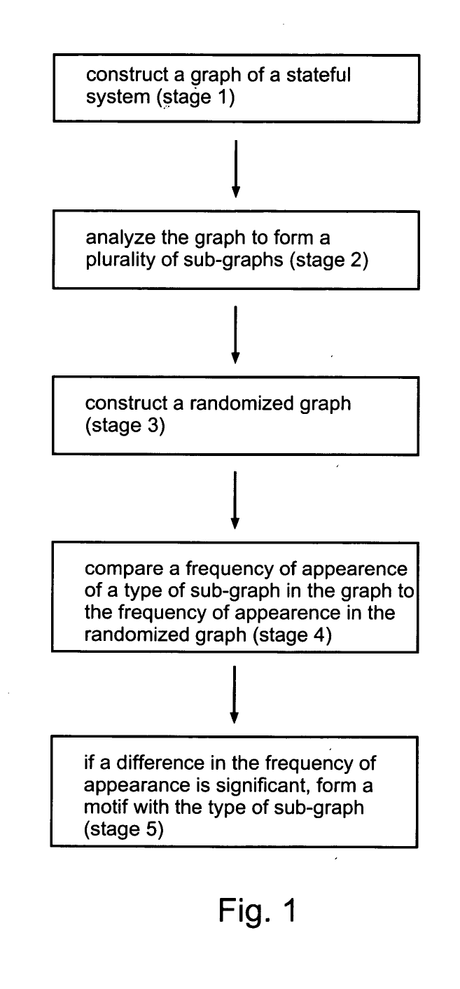

An exemplary but preferred embodiment of a method according to the present invention is shown in FIG. 1. The stages for analysis of complex systems in order to find significant motifs are detailed in the figure, and can be summarized in two parts.

The first part involves analyzing the system. This part is performed by constructing the appropriate graph for a stateful system. As previously described, the system should be stateful in order for a relationship to exist between the components of the system. In stage 2, the graph is searched for a plurality of sub-graphs. The second part preferably involves determining the significance of the motifs or sub-graphs found in the first part. In stage 3, optionally and preferably, a randomized graph is constructed. This randomized graph preferably has at least one characteristic that is similar to the graph constructed in stage 1, and more preferably, has nodes with identical characteristics to the nodes of the graph constructed in stage 1. Next, the frequency of appearance of a type of sub-graph in the graph is compared to the frequency of appearance in the randomized graph (stage 4). If a difference in the frequency of appearance is significant, such a sub-graph may be considered to be a motif. Significance may optionally and preferably be determined according to a threshold. Alternatively, significance may optionally and preferably be determined according to statistical significance of the difference between the frequencies.

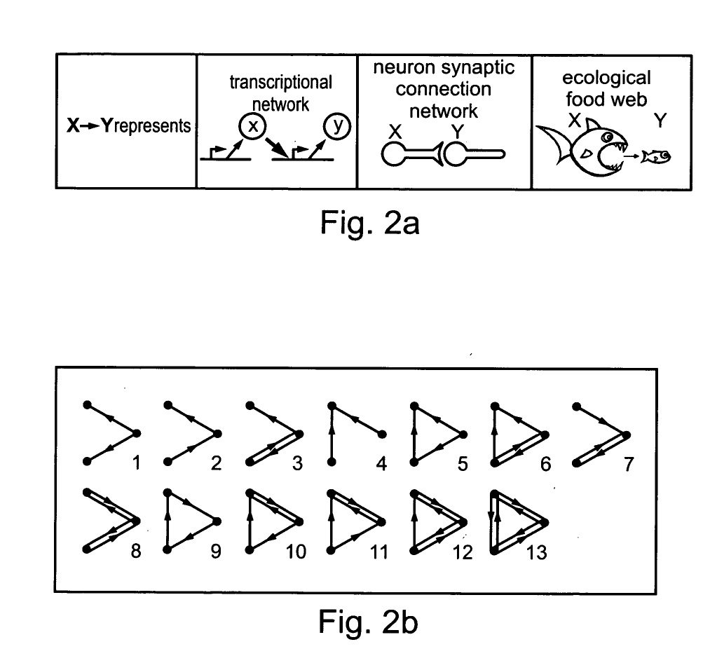

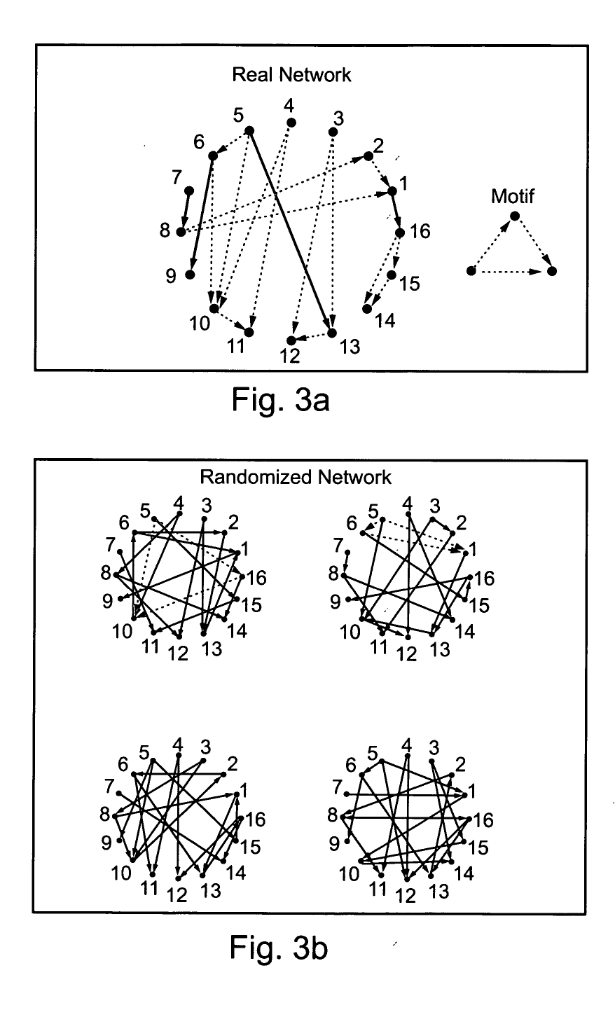

For example, consider a network that is a directed graph (where the interactions between nodes are represented by directed edges, FIG. 2a). The graph is preferably scanned for all possible n-node subgraphs (as an example only in the present study, and without any intention of being limiting, n=3 and 4), and the number of occurrences of each subgraph is recorded. Each network contains numerous types of n-node subgraphs (FIG. 2b). To focus on those that are likely to be important, the real network is preferably compared to suitably randomized networks, and such that only structures that appear in the real network at significantly higher numbers than in the randomized networks are selected (FIG. 3).

For a stringent comparison, randomized networks that have precisely the same single-node characteristics as the real network are preferably used: in the present study, each node in the randomized networks has the same number of incoming and outgoing edges as the corresponding node in the real network. The comparison to this randomized ensemble accounts for patterns that appear only because of the single-node characteristics of the network (for example, the presence of nodes with a large number of edges). A statistical significance is assigned to each pattern by comparing the number of times it appears in the real and randomized networks. To avoid assigning a high significance to a pattern only because it has a highly significant sub-pattern, the randomized networks used to calculate the significance of n-node subgraphs are generated to preserve the same number of appearances of all (n−1)-node subgraphs as the real network (17, 18).

The network motifs are preferably those patterns for which the probability P of appearing in a randomized network an equal or greater number of times than in the real network is lower than a cutoff value (here P=0.01). To detect motifs that recur in many different parts of the network, and not only around one or a few nodes, motifs that appear at least U times with completely distinct sets of nodes (here U=4) are preferably considered According to another preferred embodiment of the present invention, an algorithm based on the use of network motifs is shown, which can create a coarse-grain, simpler version of a complex network. Generally, the “coarse graining” method according to the present invention analyzes the network to obtain a set of a plurality of simpler sub-components. The set preferably contains a small number of such sub-components, relative to the size and complexity of the network as a whole, as sets with fewer components may potentially provide greater ease of understanding of the network. This set preferably acts as a “dictionary” for understanding the functionality and structure of the network, and enables a complex network to be reduced to a group of simpler structures. The relationship between these structures and their place in the network enables such a complex network to be more easily analyzed and understood.

According to an optional but preferred implementation of the method of the present invention, each sub-component is a sub-graph, and is preferably a Structurally Independent Unit (SIU). SIUs are subgraphs that can optionally and preferably serve as nodes, in a coarse-grained network. The method of the present invention preferably selects a set of SIUs that has few members each of which is as simple as possible, and that makes the newly formed network as small as possible. The set may also contain only a single SIU. The size of the newly formed network may be measured by the number of nodes and edges that were eliminated by the process.

Optionally and preferably, the set of SIUs selected by the present invention is selected according to a simplicity measure, for example the number of ports connecting a sub-component of the network with the rest of the network. The set of SIUs found is then reduced to the set that maximizes a scoring function, for example with regard to simplicity, as described in greater detail below. The maximum of the scoring function is preferably found by using a simulated annealing procedure, in which the temperature during the annealing is gradually lowered. A lower temperature results in reduced energy of the system, which consequently results in a maximal score for the scoring function, and therefore a minimal temperature is desirable. A Metropolis Monte-Carlo procedure is used to determine the probability (according to min{1, E^{ΔScore/Temperature}}) according to which a different configuration is accepted. As the temperature is gradually lowered the solution settles in a global maximum of the score.

In the preferred embodiment of the present invention, the simulated annealing process is preferably used to find suitable SIUs. In the implementation of the simulated annealing algorithm, the subset of sub-graphs used are then grouped according to their connectivity to the rest of the graph, when counting the number of ports in each sub-graph, into candidate SIU groups. In each group of candidate SIUs, any two occurrences that are overlapping are discarded. Network motifs were found to be the best candidates for the SIUs and may therefore optionally be used as an initial group of SIUs for the method of the present invention.

According to the present optional, illustrative example, the set comprises a small dictionary of simple sub-graph types, which are used to analyze and understand the function of the network in terms of recurring building blocks. This “coarse grained” analysis preferably examines networks at a lower level of structure, as described in greater detail below. The “coarse-graining” process is optionally and preferably repeated on multiple levels of the network. In each such repetition the network is simplified to contain fewer nodes and connections, which represent a new network on which the next iteration of the coarse-graining algorithm is performed. Additionally, in each such iteration each node (SIU) becomes more complicated as it contains at least one SIU from the set obtained in the previous coarse-graining iteration. The method can optionally and preferably be applied to electronic circuits and to protein signaling pathways, as non-limiting examples of networks for which the present invention is suitable.

Attempts at reducing the size of a graph representing a network have previously been made, though all were different from the method taught by the present invention, such as the SUBDUE Knowledge Discovery System described above. As described, SUBDUE is directed at changing the complex graph into a simpler graph by replacing recurring sub-graphs with a single node representing them. The algorithm of SUBDUE is implemented as an inexact search, as an exact search of all sub-graphs is computationally intractable, and is therefore error prone.

The present invention is distinct from the algorithm taught by SUBDUE, as it uses the network motifs that were found as a starting point when searching for SIUs, and is not directed at changing the original graph but at providing a better understanding of the network when it is simplified. More specifically, when discussing the data-compression problem in the network, the inherent difference of nodes inside a selected sub-graph is considered (for example input nodes, output nodes, internal nodes and mixed nodes). These features do not exist in the SUBDUE algorithm.

### EXAMPLE 1

### Method for Analysis

Network motif detection: To efficiently count all connected n-node subgraphs in a connectivity matrix M, the algorithm loops through all rows i. For each nonzero element (i,j), it loops through all connected elements Mᵢₖ=1, Mₖᵢ=1, Mⱼₖ=1 and Mₖⱼ=1. This is recursively repeated with elements (i,k), (k,i), (j,k) and (k,j) until an n-node subgraph is obtained. A table is formed which counts the number of appearances of each type of subgraph in the network, correcting for the fact that multiple submatrices of M can correspond to one isomorphic architecture due to symmetries. This process is repeated for each of the randomized networks. The number of appearances of each type of subgraph in the random ensemble is recorded, to assess its statistical significance. The present concepts and algorithms are easily generalized to non-directed or directed graphs with several ‘colors’ of edges and nodes, multi-partite graphs etc.

Criteria for Network Motif Selection:

For the purposes of the present study and without any intention of being limiting, network motifs are subgraphs which meet the following criteria:

(i) The probability that it appears in a randomized network (see below for a discussion of randomized networks) an equal or greater number of times than in the real network is smaller than P=0.01. In the present study, P was estimated (or bounded) by using 1000 randomized networks.

(ii) The number of times it appears in the real network with distinct sets of nodes is greater than U=4.

(iii) The number of appearances in the real network is significantly larger than in the randomized networks: Nreal−Nrand>0.1 Nrand. This is done to avoid detecting as motifs some common subgraphs which have only a slight difference between Nrand and Nreal, but have a narrow distribution in the randomized networks.

Gate array detection. An algorithm for detecting dense regions of interactions in the network was optionally performed as follows (the example given is for gene transcription as an illustrative, non-limiting example only). All operons regulated by two or more TFs were considered. A (non-metric) distance measure between operons k and j, based on the number of TFs regulating both operons, was defined: d(k,j)=1/(1+(ΣₙfₙM_{k,n}M_{j,n})²), where fₙ=½ if the n^{th} TF regulates more than 10 operons, else fₙ=1. Using this distance measure, the operons were clustered with a standard average-linkage algorithm¹⁹. Gate arrays corresponded to clusters with over 15 connections, with a ratio of connections to TFs greater than 2, and a splitting distance²⁰ larger than the mean splitting distance (˜0.36). The splitting distance is a measure of the separation of the cluster from the rest of the network, defined by the linkage distance at which the cluster is merged into a larger cluster minus the linkage distance at which its two sub-clusters were merged. Finally, all additional operons (those regulated by a single TF), which are regulated by TFs participating in a single gate array, were included in that gate array.

Generation of Randomized Networks:

Two different algorithms were used to generate randomized networks with the same incoming and outgoing degree per node as the real network. The two algorithms gave identical results for the subgraph statistics.

Algorithm A: A Markov-chain algorithm was employed (S. Shen-Orr, R. Milo, S. Mangan, U. Alon, Nat Genet 31, 64-8 (2002); P. Holland, S. Leinhardt, D. Heise, Ed. (Jossey-Bass, San Fransisco, 1975) pp. 1-45) based on starting with the real network and repeatedly swapping randomly chosen pairs of connections (X1→Y1, X2→Y2 is replaced by X1→Y2, X2→Y1) until the network is well randomized. Switching is prohibited if the either of the connections X1→Y2 or X2→Y1 already exist.

Algorithm B: Identical statistics were obtained using a direct construction algorithm, modified from S. Wasserman, K. Faust, Social Network Analysis (Cambridge University Press, 1994). As in algorithm A, this algorithm does not allow spurious multiple connections between nodes (more than one directed connection between two nodes). Each network was presented as a connectivity matrix M, such that Mᵢⱼ=1 if there is a connection directed from node i to node j, and 0 otherwise. The goal is to create a randomized connectivity matrix, Mrand, which has the same number of nonzero elements in each row and column as the corresponding row and column of the real connectivity matrix: Rᵢ=ΣⱼMrandᵢⱼ=ΣⱼMᵢⱼ, Cᵢ=ΣᵢMrandᵢⱼ=ΣᵢMᵢⱼ.

To generate the randomized networks, the algorithm starts with an empty matrix Mrand. Next, a row n is chosen repeatedly and randomly according to the weights pᵢ=Rᵢ/ΣRᵢ and a column m according to the weights qⱼ=Rⱼ/ΣRⱼ. If Mrandₙₘ=0, Mrandₘₙ is set to be=1. Then one sets Rₘ=Rₘ−1 and Cₙ=Cₙ−1. If the entry (m,n) was previously entered to the randomized matrix, that is if Mrandₘₙ=1, or if m=n, a new (m,n) is chosen. This process is repeated until all Rᵢ=0 and Cⱼ=0. Rarely the algorithm can find no solution, and the process is started from the beginning.

Controlling for Appearances of (n−1)-Node Motifs:

A series of randomized network ensembles are generated, each of which has the same (n−1)-node subgraph count as the real network, as a null hypothesis for detecting n-node motifs. This is done to avoid assigning high significance to a structure only due to the fact that it includes a highly significant sub-structure.

(a) For a null hypothesis randomized network as a basis for detecting 3-node motifs, the numbers of the in- and out-going edges for each node are preferably preserved, as well as the number of mutual edges (X←→Y) for each node. This is implemented using algorithm A, treating double edges and single edges separately. A double edge is switched only with a different double edge (X1←→Y1, X2←→Y2 to X1←→Y2, X2←→Y1), and only if both (X1 and Y2) and (X2 and Y1) are unconnected by an edge in any direction. Similarly, the single directed edge switches (X1→Y1, X2→Y2 is replaced by X1→Y2, X2→Y1) are performed only if they do not form new double edges.

(b) For a random null hypothesis network for assigning significance to the 4-node subgraphs, randomized networks are preferably generated that have the same 3-node subgraph counts as the real network. This is done using a Metropolis Monte-Carlo approach (R. Kannan, P. Tetali, S. Vempala, Random Structures and Algorithms 14, 293-308 (1999). Let Vrealₖ, k=1 . . . 13, be the number of appearances of each of the thirteen 3-node subgraphs (FIG. 2b) in the real network, and Vrandₖ be the corresponding vector in the randomized network. One defines an energy E=Σₖ|Vrealₖ−Vrandₖ|/(Vrealₖ+Vrandₖ). The energy E is zero only when all the 3-node subgraph counts of the real and randomized graphs are equal.

The process starts by fully randomizing the network according to algorithm A above. Then, a random switch is generated (X1→Y1, X2→Y2 to X1→Y2, X2→Y1, and similarly for double edges, as described above). If this switch lowers E, it is accepted. Otherwise, it is accepted with probability exp(−ΔE/T), where ΔE is the difference in energy before and after the switch, and T is an effective temperature. This process is repeated, using a simulated annealing regiment (14, 15) to lower T slowly until a solution with E=0 is obtained. This can be readily generalized to form (n−1)-node null-hypothesis networks for detecting n-node motifs also for n>4.

Algorithms for non-directed networks: Algorithm A was used, treating all edges as double-edges as described above.

Network Motifs in Non-Directed Networks:

Table 1 shows subgraphs and motifs in non-directed networks. Shown are all two types of 3-node and six types of 4-node non-directed subgraphs, and their concentration C in two networks (C is the fraction of times a given n-node sub-graph occurs among the total number of occurrences of all possible n-node subgraphs). The networks are a 2212 node/4406 edge yeast protein-interaction database(16) and a 228,262 node/640,294 edge database of connections between internet routers. For non-directed connections representing a router-level map (for the Internet analysis), see www.isi.edu/˜hongsuda/pub/int081099.adj.,gz (B. Huberman, L. Adamic, Nature 401, 131 (1999)). Motifs are indicated along with their Z-score. ND—not determined due to the fact that the subgraph did not appear in the randomized network ensemble. Anti-motifs are subgraphs which satisfy: (i) the probability that they appear in randomized networks fewer times than the real network is P<0.01. (ii) Nrand−Nreal>0.1 Nrand.

TABLE 1

| Pattern | Protein Interactions | Internet routers |
|---|---|---|
| 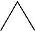 | Not a motif. C = 0.981 | Not a motif C = 0.978 |
| 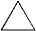 | Motif (Z = 48) C = 0.019 | Motif (Z = 4600) C = 0.023 |
| 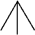 | Motif (Z = 18) C = 0.680 | Not a motif C = 0.931 |
| 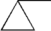 | Motif (Z = 4.4) C = 0.024 | Motif (Z = 31) C = 0.014 |
| 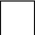 | Anti-motif (Z = −23) C = 0.292 | Anti-motif (Z = −7) C = 0.050 |
| 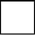 | Motif (Z = 3.6) C = 0.0013 | Motif (Z = 79) C = 8e−4 |
| 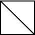 | Motif (Z = 36) C = 0.0019 | Motif (Z ND) C = 0.002 |
| 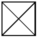 | Motif (Z ND) C = 4e−4 | Motif (Z ND) C = 6e−4 |

### EXAMPLE 2

### E. coli and S. cerevisiae Transcriptional Networks

The method of the present invention, performed as previously described in Example 1, was tested for the analysis of the E. coli and S. cerevisiae transcriptional networks. For this purpose, well-mapped transcriptional networks were selected, of organisms from two different kingdoms: that of the bacterium E. coli^{1,17} and that of the eukaryote yeast Saccharomyces cerevisiae²¹.

One of the best-characterized regulation networks is that of direct transcriptional interactions in the bacterium Escherichia coli^{1,4}. The method of the present invention was able to determine that much of the network is composed of repeated appearances of three highly significant network motifs. Each network motif has a specific function in determining gene expression. The motifs also allow an easily interpretable view of the entire known transcriptional network of the organism. The results of the analysis showed an unexpected organization of this biological network, dominated by a layer of shallow overlapping cascades. A similar result was shown for S. cerevisiae.

For E. coli, a dataset of direct transcriptional interactions between transcription factors (TFs) and the operons they regulate (an operon is one or more genes transcribed on the same mRNA) was compiled. This database contains 577 interactions between 116 TFs and 419 operons. It was based on an existing database (RegulonDB)^{1,22,23}. The RegulonDB database was enhanced by an extensive literature search, adding 187 new interactions, and 35 new TFs, including alternative sigma factors. The dataset consists of established interactions in which a TF directly binds a regulatory site, supported by biochemical (DNA binding, in vitro transcription) evidence.

Data from RegulonDB (version 3.2, XML format) included 81 TFs, with 624 interactions between TFs and sites. In the present study, interactions with multiple promoters for the same operon were unified, as were interactions of a TF with multiple binding sites in the same promoter region. Unified interactions of different signs (negative/positive) were registered as ‘dual’. Interactions of unknown type, or those based solely on micro-array data were not included. This reduced the effective number of interactions in RegulonDB to 390. RegulonDB data was extended by adding 35 new TFs and 187 new interactions, collected through a literature search. Notably, alternative sigma factors were added. In most cases, the new interactions added were supported in the literature both by in-vivo genetic experiments and in-vitro DNA binding data. Most (58%) of the interactions are positive, due largely to the addition of the alternative sigma factors as TFs. Of the 58 autoregulatory interactions (50% of all TFs), a majority are autorepressors (70%). The distribution of the number of TFs controlling an operon is compact, whereas the distribution of the number of operons regulated by a TF is long-tailed with an average of ˜5.

The S. cerevisiae transcriptional network, with 690 nodes and 1094 connections, was taken from the YPD database²¹, where nodes with outgoing arrows are transcription factors. In yeast, several transcription factors jointly operate as subunits of a regulatory protein complex. This could generate different circuits and patterns that are not informatory. To correct for this, each group of transcription factors that function in a complex was united into a single node.

Transcriptional Interaction Database.

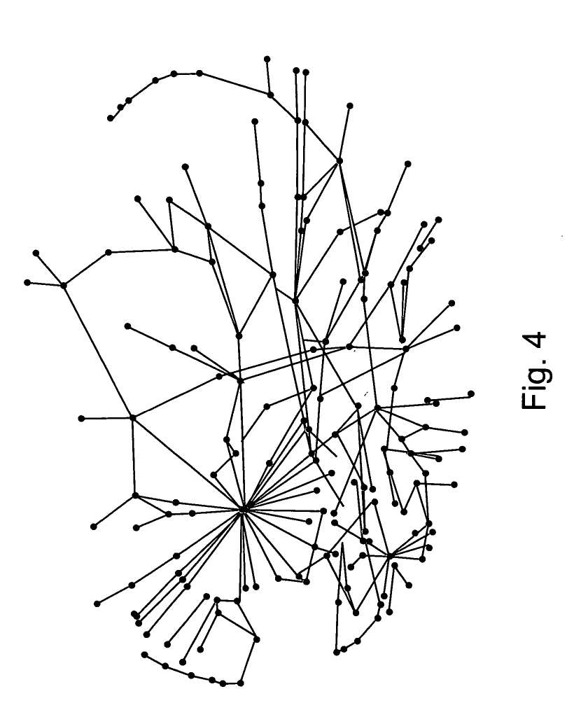

The transcriptional network can be represented as a directed graph. The complex network of direct transcriptional interactions in the E. coli dataset are displayed in FIG. 4 as a schematic representation only, to provide a visualization of the complexity thereof. Network visualization was done using the Pajek program for large network analysis and visualization which can be found at http://vlado.fmf.uni-lj.si/pub/networks/pajek/pajekman.htm. Each node represents a gene or an operon. Edges represent direct transcriptional interactions. Each edge is directed from a gene or an operon that encodes a TF to a gene or an operon that is regulated by that TF. One of the goals of the present study was to simplify and understand this complex graph by defining its basic building blocks. For this purpose, the network with algorithms aimed at detecting recurring patterns was scanned according to the previously described method. The statistical significance of the network motifs was evaluated by comparison to randomized networks with is the same basic statistics as the true E. coli network. The probability that a randomized network had an equal or greater number of motifs than the true network (‘P-value’) was assigned by enumerating the motifs found in 1000 randomized networks.

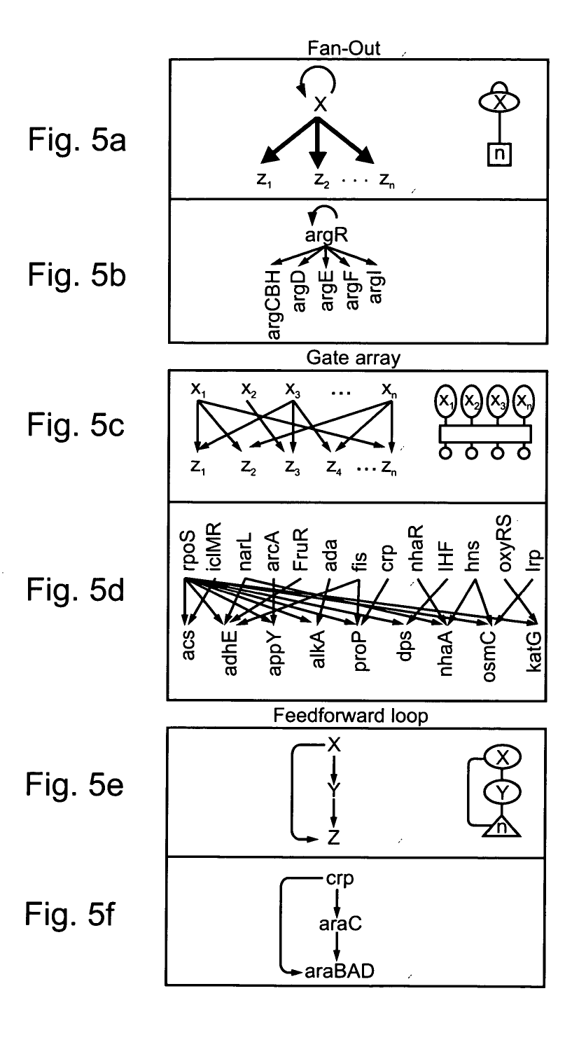

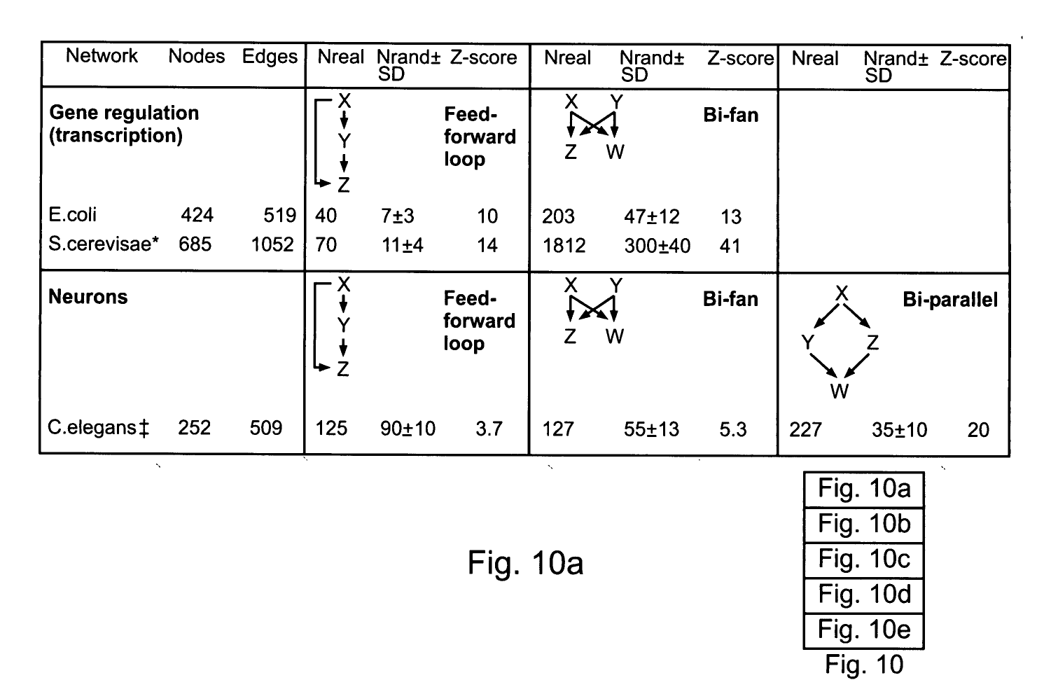

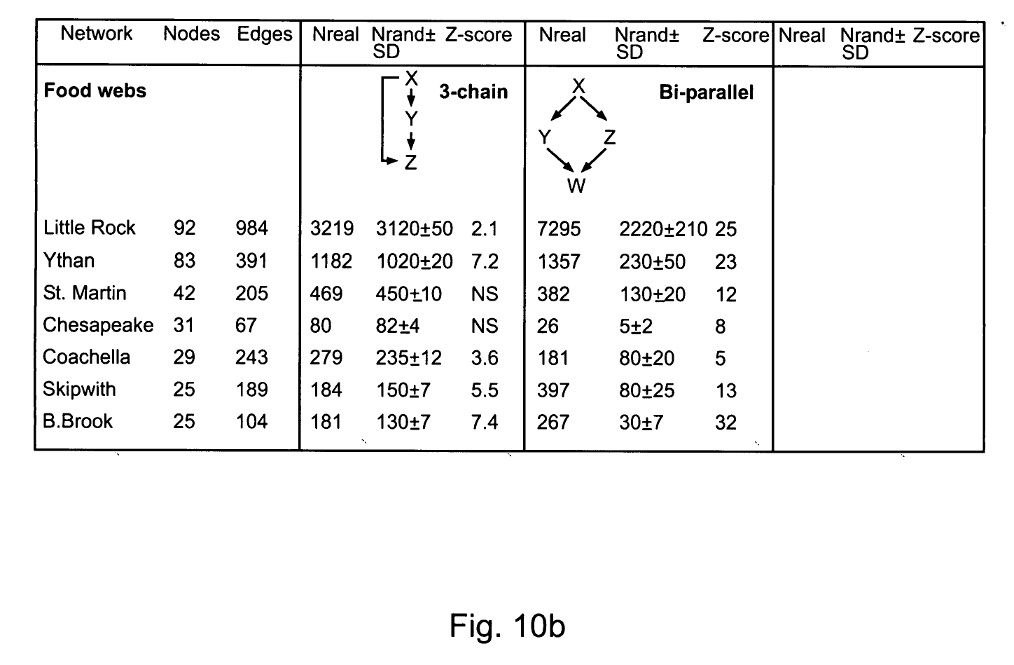

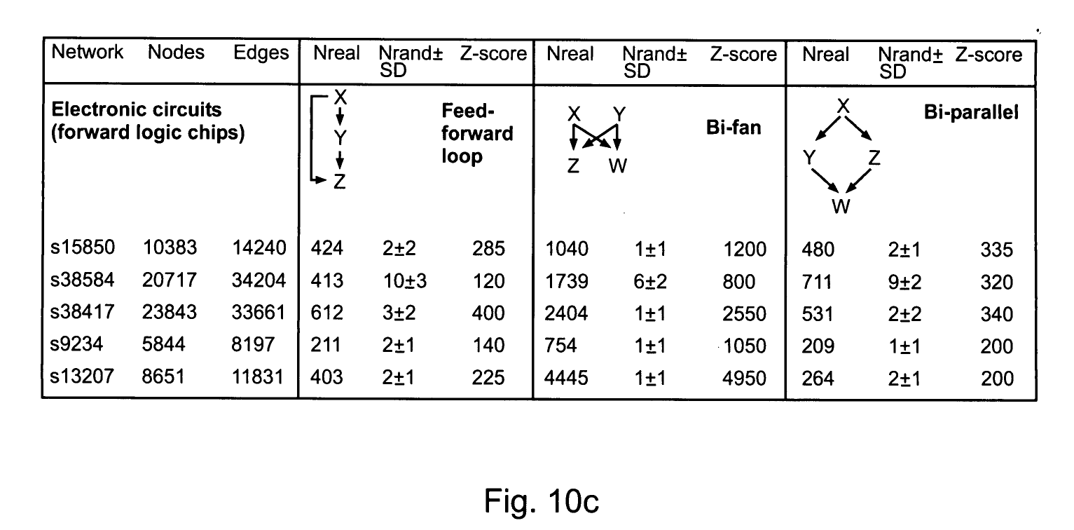

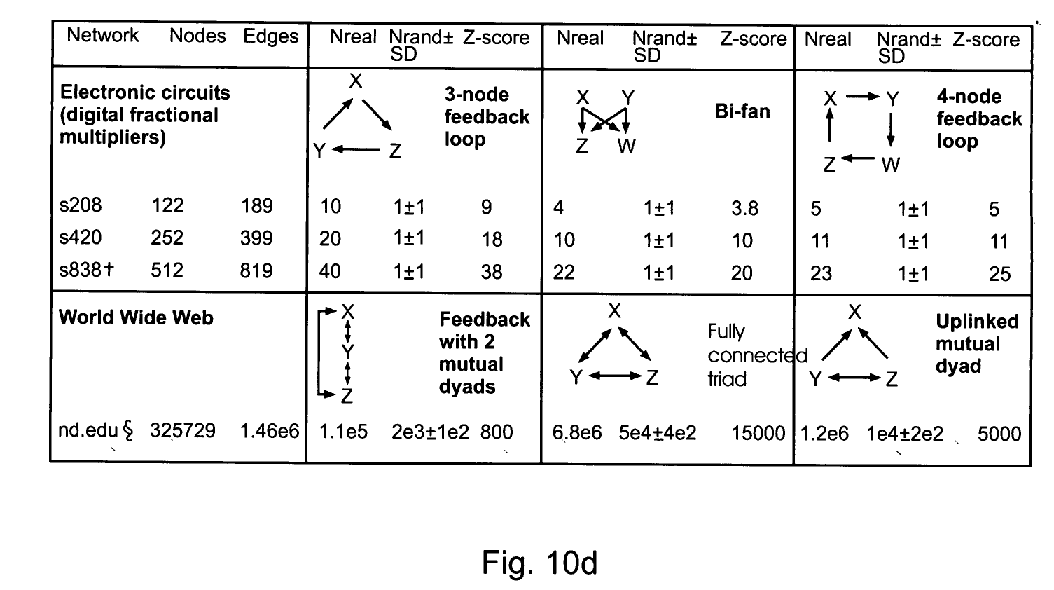

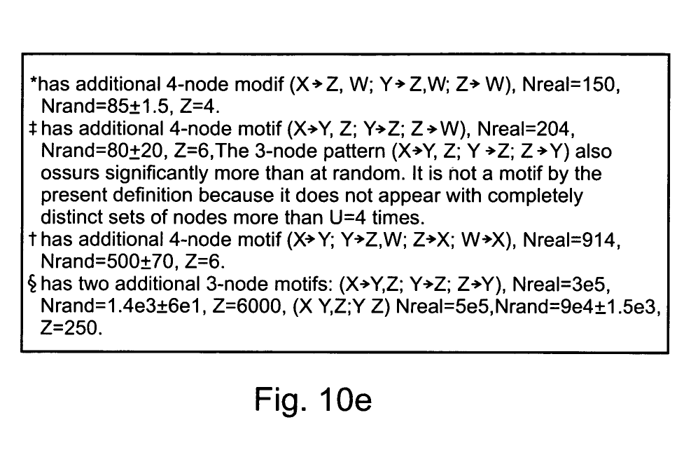

The motifs found in the E. coli network are shown in FIG. 5 and in FIG. 10. The motifs for S. cerevisiae are also shown in FIG. 10. The arrows displayed in the figure represent either positive or negative regulations. Symbols representing the motifs are also shown.

The first motif, termed ‘fan-out’, is defined by a set of operons that are controlled by a single transcription factor (TF) (FIG. 5A). The single controlling TF is usually autoregulatory, all of the operons are under control of the same sign (all positive or all negative), and have no additional transcriptional regulation. The TFs exhibiting the fan-out motif are usually autoregulatory (70%, mostly autorepression), in contrast to only 50% of the TFs in the complete data set.

An example is the arginine biosynthesis pathway, where the TF ArgR uniquely controls 5 operons that code for arginine biosynthesis genes (FIG. 5B). Other amino-acid biosynthesis systems also correspond to this motif. The fan-out motif appears in 24 systems in the database (counting systems with 3 or more operons). Large fan-outs (more than 15 operons) occur infrequently in randomized networks (P˜0.01) because there is a low probability that a large number of operons controlled by a single TF will have no other regulation.

The second motif, termed ‘gate array’, is a layer of overlapping interactions between operons and a group of input TFs (FIG. 5C). Specifically, gate arrays are a set of operons Z1 . . . Zm are each regulated by a combination of a set of input TFs, X1 . . . Xn. The gate arrays are defined by an algorithm aimed at detecting locally dense regions in the network, with a high ratio of connections to TFs (see Methods). An example is the set of operons regulated by RpoS upon entry into stationary phase²⁴ (FIG. 5D). Different combinations of additional TFs, including TFs that respond to various stresses and nutrient limitations, control each of these operons.

Six gate arrays are found in the present network. The operons in each gate array share common functions. Typically, every output operon is controlled by a different combination of input TFs. In rare cases, termed ‘multi-fan’ outputs, several operons in a gate array are regulated by precisely the same combination of TFs with identical regulation signs. Gate arrays are dense regions of interactions in an otherwise sparse network¹: Operons in gate arrays are regulated by 3.1 TFs on average, compared to an average of 1.4 over the entire network. Gate arrays occur rarely in randomized networks (P˜0.001) since there is a low probability for a high degree of overlap between sets of genes regulated by different TFs.

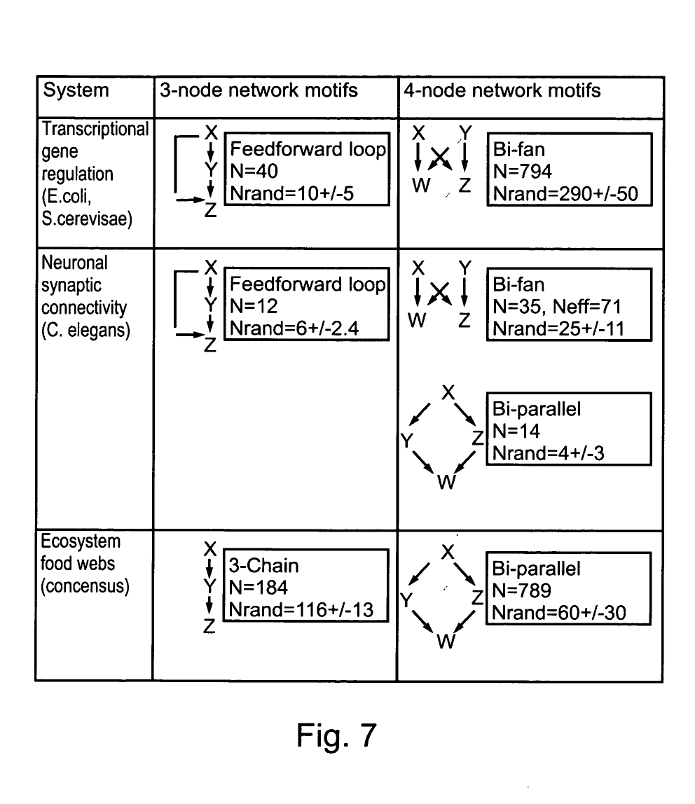

The third motif, a 3-node motif termed ‘feedforward loop^{,17} is defined by a transcription factor X that regulates a second transcription factor Y, such that both X and Y jointly regulate an operon Z (FIG. 5E, FIG. 7). Factor X may be termed the ‘general TF’, Y the ‘specific TF’, and Z the ‘effector operon(s)’. In FIG. 7, the number of appearances (N) and the mean (Nrand) ± std number of appearances in randomized networks are shown. For example, this motif occurs in the L-arabinose utilization system²⁵ (FIG. 5F). Here Crp is the general TF and AraC the specific TF. This motif characterizes 22 different systems in the network database, with 10 different general TFs and 40 effector operons.

A feedforward loop motif may be termed ‘coherent’ if the direct effect of the general TF on the effector operons has the same sign (negative or positive) as its net indirect effect through the specific TF. For example, if X and Y both positively regulate Z, and X positively regulates Y, the network is coherent. If, on the other hand, X represses Y, its effect on Z through Y is opposed to its direct effect, and the motif is ‘incoherent’. Most (82%) of the feedforward loop motifs were found to be coherent. Feedforward loops are stylized structures, which occur much more frequently in the E. coli network than in randomized networks—the number of times they appear is greater by more than 5 standard deviations than their mean number of appearances in randomized networks, with P<0.001.

In addition, another 4-node motif was found, termed ‘bi-fan’, which appears several times in the network (FIG. 7), in non-homologous gene systems that perform diverse biological functions. The number of times this motif appears in the network is greater by 9 standard deviations than the mean number of its appearance in randomized networks.

Of all three and four node motifs found using the present invention (13 three node motifs, and over two hundred different 4-node circuits), only the ‘feedforward loop’ and the ‘bi-fan’ circuits were found to be significant, and therefore can be considered network motifs. Many other three and four node circuits recur throughout the network, but at numbers that are less than the mean plus two standard deviations of their appearance in randomized networks.

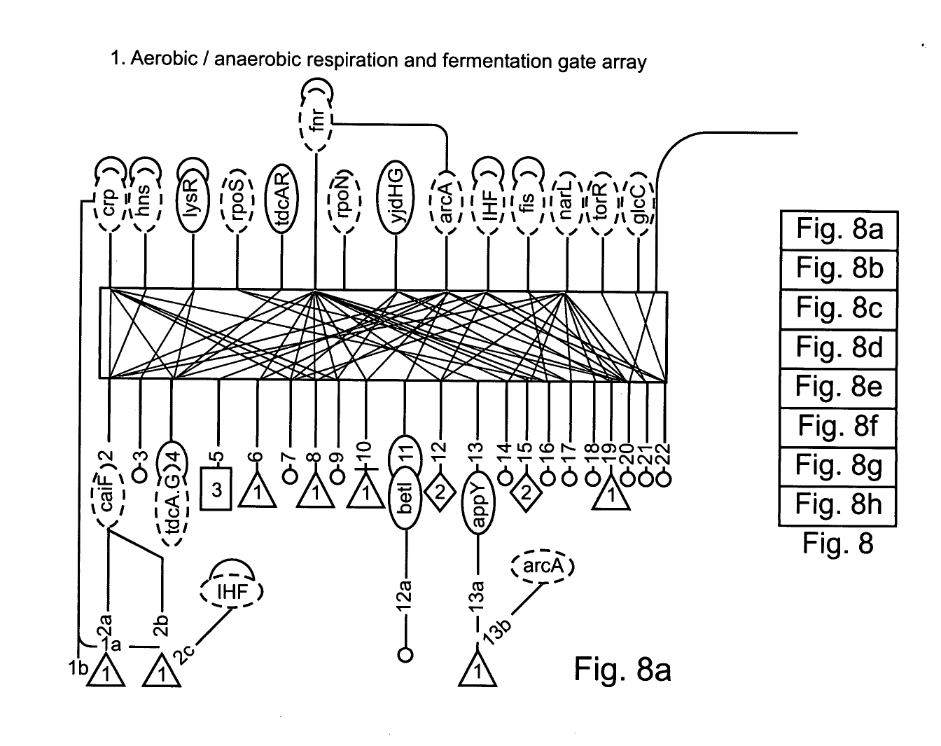

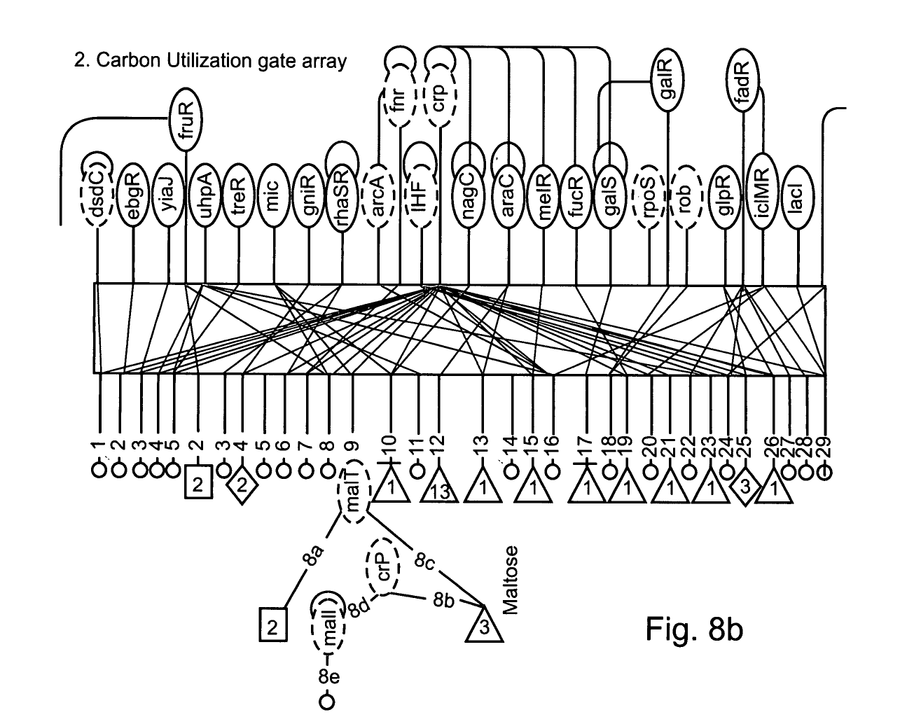

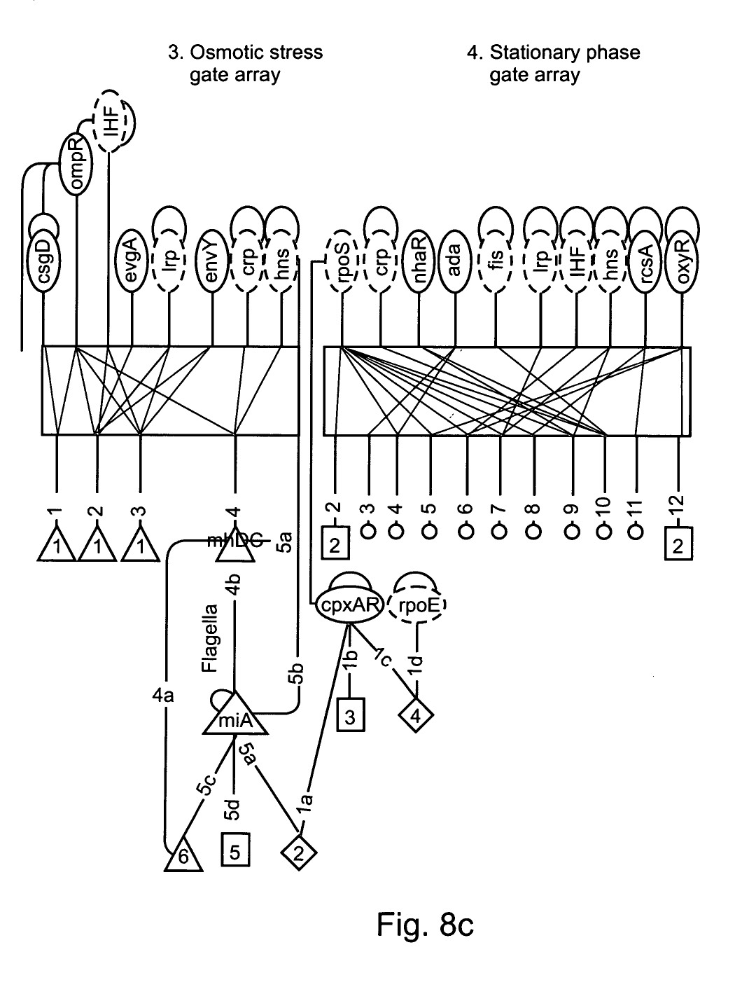

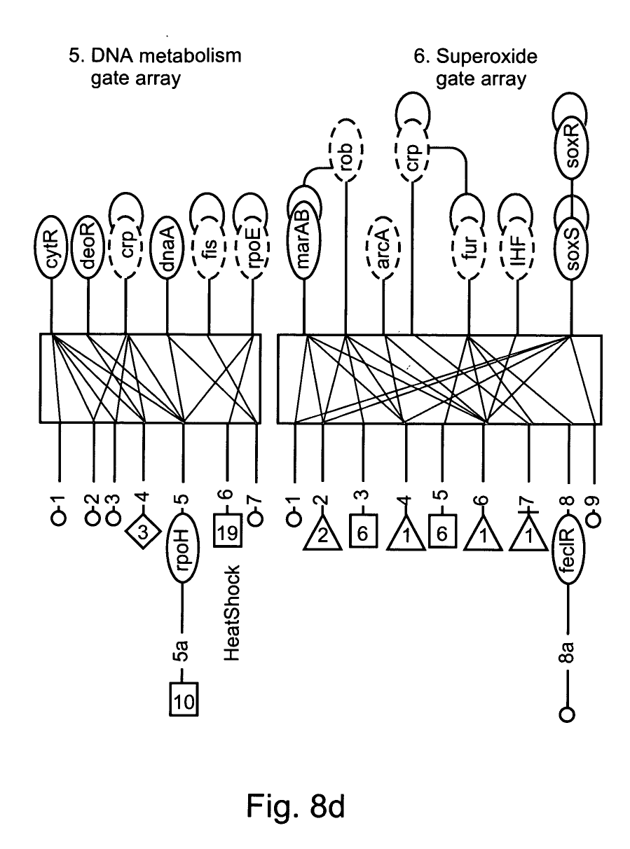

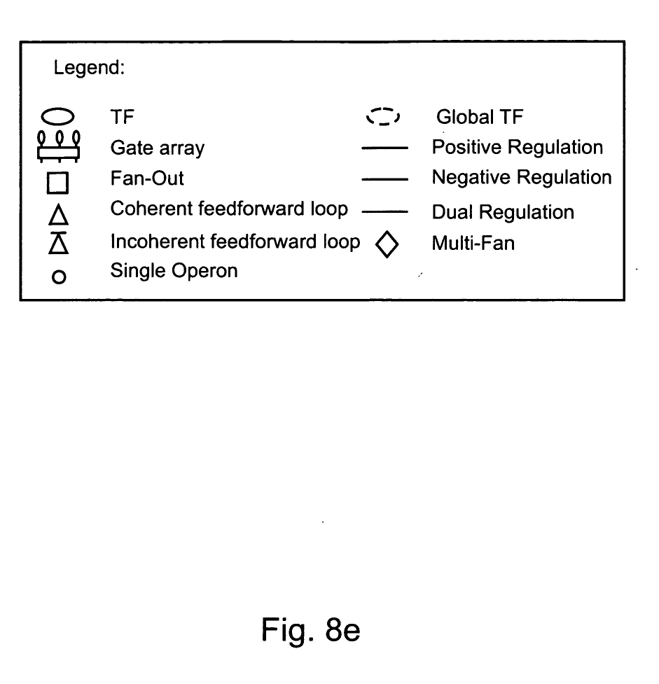

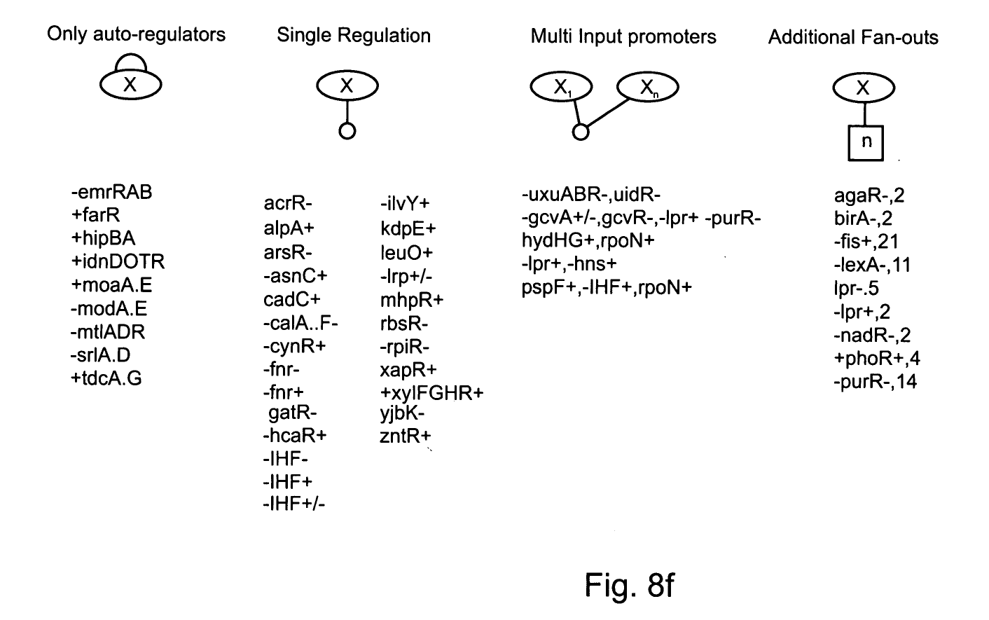

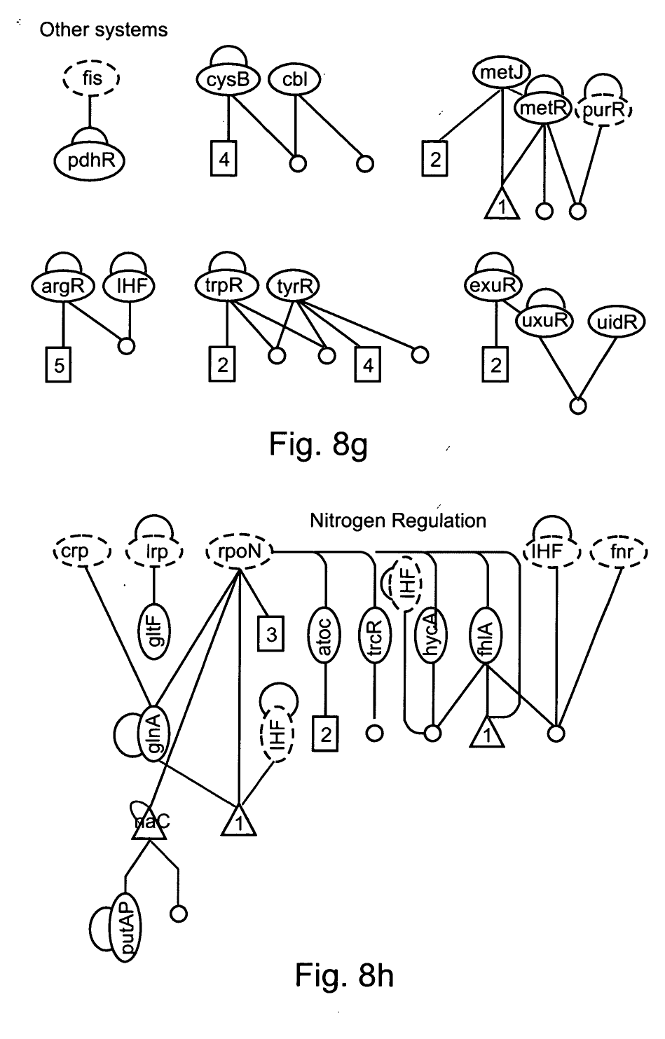

These motifs allow a representation of the entire known E. coli transcriptional network in a compact, modular, form. In FIG. 8, the complete network of direct transcriptional interactions in the E. coli dataset is represented using network motifs. Here too, nodes represent operons, and lines represent transcriptional regulation, directed so that the regulating TF is above the regulated operons. Network motifs are represented by their corresponding symbols (as defined in FIG. 5). The six gate arrays are named according to the common function of their output operons. Each TF appears in only a single subgraph, except for TFs regulating more than 10 operons (‘global TFs’), which can appear in several subgraphs. The names of the TFs participating in these systems are listed. In these lists, each TF name is preceded by the sign of its autoregulation (if any), and followed by the regulation sign and number of downstream operons (if more than 1).

By using symbols to represent the different motifs (as shown in FIG. 5), the network is broken down to its basic building blocks and a comprehensible picture emerges; for example, FIG. 8 is more easily understood than the highly complex graph of FIG. 4. A single layer of gate arrays connects most of the TFs to their effector operons. Feedforward loops and fan-outs often occur at the outputs of these gate arrays. The architecture is thus broad rather than deep, where most operons are controlled by relatively shallow cascades. A depth for each operon can be defined by the length of the longest cascade that regulates it. Most of the operons are at depth 2. There are few long cascades, such as cascades of depth 5 in the flagella and nitrogen systems. The gate array layer may therefore represent the core of the computation performed by the transcriptional network.

In the data set there are no examples of feedback loops of direct transcriptional interactions except for auto-regulatory loops, as has been previously noted¹. However, the absence of feedback loops is not statistically significant, since over 80% of the randomized networks also had no feedback loops. Transcriptional feedback loops occur in other organisms, such as the genetic switch in lambda phage⁵.

The possible functionality of the network motifs is suggested by common themes of the systems in which they appear. The fan-out motif characterizes systems of genes that function stochiometrically to form a protein assembly (flagellar motor) or a metabolic pathway (amino-acid biosynthesis). In such situations, it is useful that the overall activity of the operons is determined by a single TF, so that their proportions are fixed. In contrast, gate arrays allow the ratios between the expressions of the output operons to be tuned by multiple inputs. Thus, gate arrays appear in systems where complex responses are mobilized and affected by numerous stimuli. For example, the stationary phase gate array can ‘compute’ a different expression profile for each operon in response to many possible combinations of stresses and nutrient limitations²⁴.

The feedforward loop motif often occurs where external signals cause a rapid, general response of multiple specific systems (repression of sugar utilization systems in response to glucose, shift to anaerobic metabolism). Numerical simulation of coherent feedforward loop circuits suggests they can function to speed the system shutdown and to filter out rapid variations in the activity of the general TF (not shown). The abundance of coherent feedforward loops, as opposed to incoherent ones, also hints at a functional design. In both feedforward loops and gate arrays, multiple TFs jointly regulate the same operon. Therefore, to fully understand the computational function of these motifs would require additional information on how inputs from several TFs are integrated at the promoter regions²⁶.

The present study considered only transcription interactions specifically manifested by TFs that bind regulatory sites^{1,22,23}. This transcriptional network can be thought of as the ‘slow’ part of the cellular regulation network (time scale of minutes). An additional layer of faster interactions, which include protein-protein interactions (often subsecond timescale), contributes to the full regulatory behavior and will probably introduce additional network motifs. Characterization of additional transcriptional interactions may change the present motif assignment for specific systems. In particular, some systems characterized here as fan-outs might turn out to be of a gate array type. However, the present conclusions are generally not sensitive to addition or removal of interactions from the dataset.

Both the yeast and bacteria transcription networks show the same motifs: a 3-node motif (termed ‘feedforward loop’(11)) and a 4-node motif (termed ‘bi-fan’). These motifs appear numerous times in each network (FIG. 10), in non-homologous gene systems that perform diverse biological functions. The numbers of times they appear is greater by more than 10 standard deviations than their mean number of appearances in randomized networks. Only these, of the 13 possible different 3-node subgraphs (FIG. 2b) and 199 different 4-node subgraphs, are significant, and are therefore considered network motifs. Many other 3- and 4-node subgraphs recur throughout the networks, but at numbers that are less than the mean plus 2 standard deviations of their appearance in randomized networks.

### EXAMPLE 3

### Neuronal Connectivity Network

The method of the present invention, as previously described in Example 1 and also with regard to FIG. 1, was applied to the neuronal connectivity network of a worm (Caenorhabditis elegans)^{11,27}. Nodes represent neurons (or neuron classes) and connections represent synaptic connections between the neurons.

The C. elegans neuronal synaptic connectivity network, with 67 nodes and 99 connections, was based on the stringent set of connections defined in Ref.²⁷ consisting of neurons connected by at least 5 synapses in at least 3 of 4 sides (2 sides of 2 animals) mapped¹¹.

Within this network, the feedforward loop 3-node motif described in example 2 (FIG. 7, FIG. 5E), and two 4-node motifs, the bi-fan described in example 2, and a motif termed ‘bi-parallel’ (FIG. 7) may be found (see FIG. 10). The ‘bi-fan’ circuit in this network is significant due to its effective number of appearances which is larger than the absolute number of appearances due to the scarcity of some of its 3-node sub-circuits. The three significant motifs mentioned above, are the only network motifs found in this network.

Note that two of these network motifs, (feedforward loop and bi-fan) were also found in the transcriptional gene regulation networks. This similarity in network motifs may point to a fundamental similarity in the design constraints of the two types of networks. Both networks function to carry information from sensory components (sensory neurons/transcription factors regulated by biochemical signals) to effectors (motor neurons/structural genes).

To demonstrate this, it is noted that the feedforward loop motif common to both types of networks may play a functional role in information processing. One possible function of this circuit is to reject transient fluctuations in the input, and allow output only if the input signal is persistent.

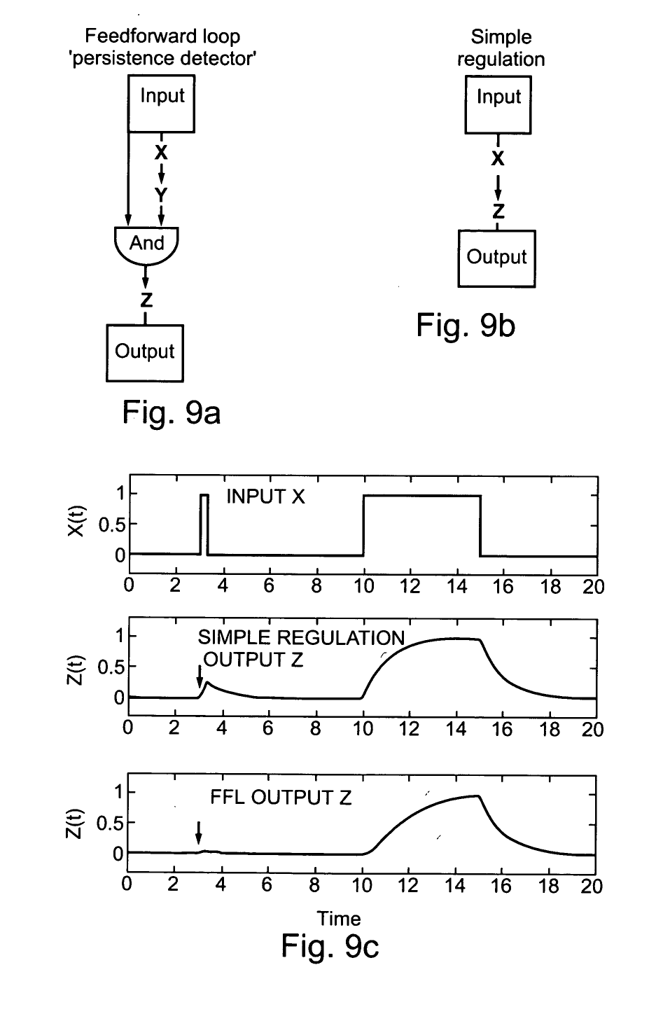

As shown in FIG. 9A, the nodes X and Y represent transcription factors, or neurons, and the node Z is the output gene or motor neuron. The input to the circuit is x(t) (activation of the transcription factor X by a biochemical signal or activation of the sensory neuron X by a stimulus). It is assumed that Z is activated only if X and Y are active, in an ‘AND-gate’ like fashion. AND-like gates are common both in transcriptional regulation and in simple models of neuron dynamics. When X is activated, the signal is transmitted to the output node Z by two pathways, a direct one from X and a delayed one through Y.

If x(t) is transient, Y cannot be activated in time for both X and Y to significantly activate Z, and the input signal is not transduced through the circuit. Only when X is activated for a long enough time so that Y levels can build up, will the output node Z be activated. Thus the circuit functions as a ‘persistence detector’.

As a simple mathematical model for this circuit, let x, y and z be the concentrations of the active proteins encoded by the genes in the circuit. The kinetic equations are

dy/dt=x−y/a

dz/dt=xy−z/a

where the term xy represents a simple AND-like gate, and a is the protein lifetime (or dilution time by cell growth), taken for simplicity to be equal for Y and Z.

This result can be compared to the simple regulation circuit shown in FIG. 9B:

dz/dt=x−z/a,

and to a two-step cascade shown in FIG. 9C.

Let the input x(t) be a pulse of duration τ (FIG. 9C). For τ<<a, the output is greatly suppressed in the FFL compared to the simple regulation circuits:

Maximal Output (feedforward loop)/Maximal Output (simple regulation)=τ/a. For example, a transient input pulse of τ=10s, at a protein lifetime of a=1000s, would be suppressed by 100-fold by the FFL circuit compared to simple regulation. Output is significant only if the input, integrated over a time a, is large enough.

The FFL circuit is essentially an AND gate over a one step cascade (FIG. 9B) and a two-step (‘3-chain’) cascade (FIG. 9C). A two-step cascade has a slow turn-off rate (rate at which Z decays when x(t) returns to zero). A one-step cascade has a fast turn-off rate but does not effectively suppress transient inputs. The FFL circuit can both suppress transient inputs and has a turn-off rate as fast as a one-step cascade. Indeed, the vast majority (90%) of the input nodes in the neuronal feedforward loops are sensory neurons, which may require this type of information processing to reject transient input fluctuations that are inherent in a variable or noisy environment.

### EXAMPLE 4

### Ecosystem Food Webs

When the method of the present invention is applied to ecosystem food webs^{10,28}, the nodes represent groups of species and connections are directed from a node representing a predator to the node representing its prey. Data collected by different groups at seven distinct ecosystems was analyzed^{10,29}. The food webs were kindly provided by N. Martinez¹⁰. The different ecosystem food webs, and the number of nodes there were in each web are listed below:

The data from Skipwith pond held 25 nodes, from Little rock lake had 92 nodes, from Bridgebrook lake had 35 nodes and from St. Martin island had 42 nodes. The data from Chesapeake Bay held 31 nodes, from Ythan estuary had 78 nodes and from Coachella valley had 29 nodes.

Each of the food webs displays one or two 3-node network motifs and one to five 4-node network motifs.

The ‘consensus motifs’ can be defined as the network motifs shared by different networks of a given type. Each of the food webs displayed one or two 3-node network motifs and one to five 4-node network motifs. The ‘consensus motifs’ can be defined as the motifs shared by networks of a given type. Five of the seven food webs shared one 3-node motif and all seven shared one 4-node motif (FIG. 10). The consensus motifs are shown in FIG. 7, together with the number of absolute appearances of the motif in the network (symbolized N) and the mean and standard deviation of the number of appearances in randomized networks.

The 3-node motif, termed ‘3-chain’ is significant, while the 3-node feedforward loop circuit (described in examples two and three, and found significant there) is underrepresented in the food webs. This suggests that direct interactions between species at a separation of two layers (as in the case of omnivores³⁰) are selected against.

The ‘bi-parallel’ motif (described in example 3) indicates that prey of a given predator both tend to share the same prey. Both network motifs may thus represent general tendencies of food webs^{10,28}.

### EXAMPLE 5

### Technological Networks

The technological networks studied include the ISCAS89 benchmark set of sequential logic electronic circuits (7A, 25A). The nodes in these circuits represent logic gates and flip-flops. These nodes are linked by directed edges. Electronic circuits were directly parsed from the ISCAS89 benchmark dataset(8), available at www.cbl.ncsu.edu/CBL_Docs/iscas89.html. The parsed networks are available at www.weizmann.ac.il/mcb/UriAlon.

The motifs separate the circuits into classes that correspond to the circuit's functional description. In FIG. 10 two classes are presented, featuring of five forward-logic chips and three digital fractional multipliers. The digital fractional multipliers share three motifs including 3- and 4-node feedback loops. The forward logic chips share the feedforward loop, bi-fan and bi-parallel motifs, which are similar to the motifs found in the genetic and neuronal information-processing networks.

For the World Wide Web, the database of L. Amaral, A. Scala, M. Barthelemy, H. Stanley, PNAS 97, 11149-11152 (2000) was used, which is available at www.nd.edu/˜networks/database/index.html.

A completely different set of motifs are found in a network of directed hyperlinks between World-Wide Web pages within a single domain(4A). The World-Wide Web motifs may reflect a design aimed at short paths between related pages. Application of the present approach to non-directed networks shows distinct sets of motifs in networks of protein interactions and internet router connections.

### EXAMPLE 6

### Coarse Graining of Complex Networks

Understanding the design of complex networks, a task know as reverse-engineering, is a major goal in many fields, including biology and engineering. An algorithm based on the use of network motifs is shown, which can create a coarse-grain, simpler version of a complex network. Generally, the “coarse graining” method according to the present invention analyzes the network to obtain a set of a plurality of simpler sub-components. The set preferably contains a small number of such sub-components, relative to the size and complexity of the network as a whole, as sets with fewer components may potentially provide greater ease of understanding of the network. This set acts as a “dictionary” for understanding the functionality and structure of the network, and enables a complex network to be reduced to a group of simpler structures. The relationship between these structures and their place in the network enables such a complex network to be more easily analyzed and understood.

According to the present optional, illustrative example, the set comprises a small dictionary of simple sub-graph types, which are used to analyze and understand the function of the network in terms of recurring building blocks. This “coarse grained” analysis preferably examines networks at a lower level of structure, as described in greater detail below.

According to an optional but preferred implementation of the method of the present invention, each sub-component is a sub-graph, and is preferably a Structurally Independent Unit (SIU). SIUs are subgraphs which can optionally and preferably serve as nodes, in a coarse-grained network. The method of the present invention preferably selects a set of SIUs that has few members each of which is as simple as possible, and that makes the newly formed network as small as possible. The set may also contain only a single SIU. The size of the newly formed network may be measured by the number of nodes and edges that were eliminated by the process.

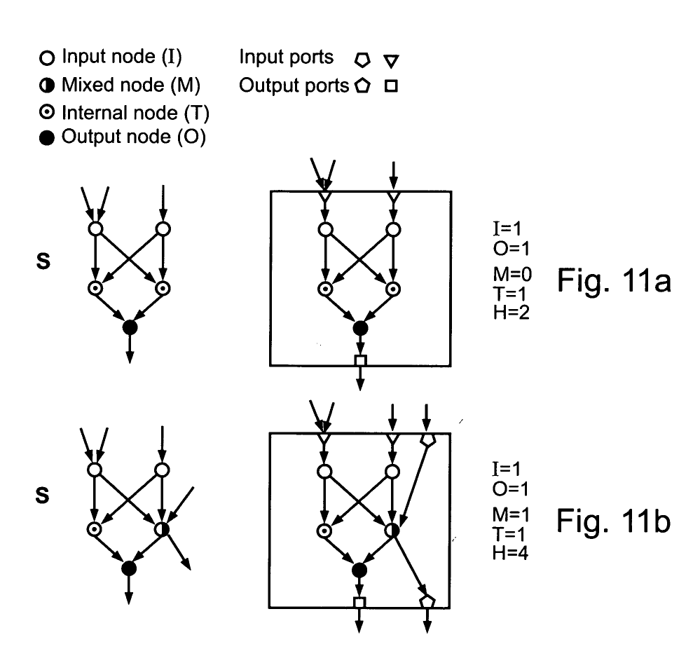

Simplicity of an SIU is defmed according to properties of the sub-graph S represented by the SIU. Each occurrence of the sub-graph S in the network is described as a “black box” with input ports and output ports, representing the connection of S with the rest of the network R as seen in FIG. 11. There can be four types of nodes in S: input nodes receive only incoming edges from R; output nodes only have outgoing edges to R; internal nodes have no connection to R; and mixed nodes have incoming and outgoing edges connecting them with R. The SIUs referred to in the method of the present invention have a threshold number of mixed nodes, the threshold number being predetermined. In cases where two nodes are structurally equivalent (Kashtan, N., Itzkovitz, S., Milo, R. & Alon, U. Network motifs in biological networks: Roles and Generalizations. Submitted (2003)) and thus switching them preserves the connectivity of S, they are considered as one node. The simplicity measure for S is defmed as the number of ports H=I+O+2M where I is the number of input nodes, O is the number of output nodes, and M is the number of mixed nodes.

There are a large number of sub-graphs that can serve as candidate SIUs. Reduction of the candidate number is achieved by considering only sub-graphs that occur in the network significantly more often than in a randomized graph, and can therefore be considered network motifs. The optimal set of SIUs is optionally and preferably chosen by maximizing the scoring function

dE+a·dP−bΣᵢ₌₁^{N}Hi−cΣ_{i'2}^{N}Ti (2)

where dE is the difference between the number of edges in the original network and in the coarse-grained network, dP is the difference between the number of nodes (ports) in the original network and in the coarse-grained network, N is the number of different SIUs and hence corresponds to the conciseness of the dictionary, and Hi and Ti correspond to the complexity of the SIU. Hi denotes the number of nodes in SIUᵢ that are connected to the outside network, and Ti is the number of internal nodes in SIUᵢ (e.g. nodes which are only connected within SIUᵢ), although optionally any other measure may be used. The parameters a, b, and c can be set for various degrees of coarse graining, and are preferably set to a=b=1, c=5. However, results (brought below) show that there are cases in which the solution is insensitive to the exact choice of optimization parameters.

Maximization of equation (2) favors the use of a small set of SIUs, preferentially ones that appear often, and have few mixed nodes. Additionally, it favors large and dense SIUs, containing many nodes and edges, but that can be represented by few port connections to R. The last term in the function bounds the SIU size, and prevents the trivial solution where the entire network is replaced by a single SIU.

However, finding an optimal coarse-grained network according to function (2) would entail enumerating all sub-graph appearances of all sizes. As this is computationally intractable, only a small subset of all possible sub-graphs is considered, including sub-graphs which are good candidates for optimal coarse-graining. Network motifs, found according to the algorithm described in Example 1, preferably form the subset of sub-graphs that are used.

Once the subset of sub-graphs to be used is found, the simulated annealing approach (Kirkpatrick, S., Gelatt, C. & Vecchi, M. Optimization by simulated annealing. Science 220, 671-680 (1983)) detailed below is taken in order to find the optimal set of SIUs for coarse graining.

Simulated annealing is a method for finding a minimum value of a collection of objects, exploiting an analogy between the way in which a metal cools and freezes into a minimum energy crystalline structure (the annealing process) and the search for a minimum in any generalized system that features a collection of objects. The major advantage simulated annealing has over other methods for finding a minimum value is an ability to avoid becoming trapped at local minima.

Generally, the algorithm employs a random search which not only accepts changes that decrease objective function f, but also some changes that increase it. The latter are accepted with a probability

$$p = exp ( - \frac{δ f}{T} )$$

where δƒ is the increase in f and T is a control parameter, which by analogy with the original application is known as the system ‘temperature’ irrespective of the objective function involved.

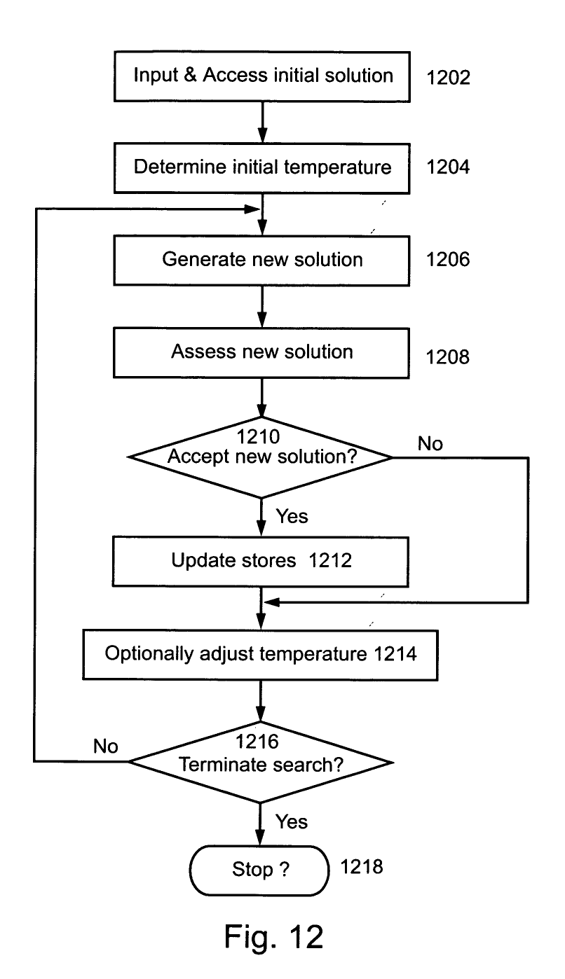

As described in FIG. 12 in stage 1202 of the algorithm, an initial solution, received by some initial algorithm or in a heuristic way, is input to the algorithm and assessed by it. In the next stage 1204 the initial temperature is set, preferably according to a predefined minimal number which is preferably relatively high. A new solution is then generated in stage 1206 according to the input and estimated is distance, and this new solution is then assessed in stage 1208. Next, in stage 1210, in order to decide whether to accept the new solution, the Metropolis Monte-Carlo procedure is followed as previously described. If the new solution is accepted the scores are updated (stage 1212), and in any case the temperature is reduced in stage 1214. Optionally the temperature may not be reduced for each cycle, such that this stage may optionally be skipped for some cycle(s) (for example for every other cycle, or for every 1,000 cycles). In the next stage 1216, a decision is made whether to terminate the procedure. This decision may optionally be made according to a predefined number of partial solutions being reached, the temperature or distance measure reaching a predefined value, or when the procedure ceases to make progress. In a case of continuation, the procedure returns to stage 1206, generates a new solution according to the present solution and temperature, and continues from there as before. Otherwise, the procedure is stopped.

In the present invention, the simulated annealing process is preferably used to find suitable SIUs. In the implementation of the simulated annealing algorithm, the subset of sub-graphs used are then grouped according to their connectivity to the rest of the graph, when counting the number of ports in each sub-graph as described above, into candidate SIU groups. In each group of candidate SIUs, any two occurrences that are overlapping are discarded. Network motifs may optionally be used to select candidate SIUs as previously described.

Each SIU candidate is optionally assigned a spin variable, which has the value 1 if all occurrences participate in the coarse-graining and 0 otherwise. The “active set” of SIUs is composed of SIUs having spin 1. For each SIU in the active set all occurrences are coarse grained, and for each occurrence overlapping sub-graphs from other SIUs candidates in the active set are removed. A greedy algorithm is used to determine the order in which SIU candidates are coarse-grained, where at each step a candidate SIU from the remaining active set is chosen with a probability that is proportional to the number of edges in the network that are covered by the occurrences of the candidate SIU. The resulting new active set is accepted with a Metropolis Monte-Carlo procedure (Newman, M. & Barkema, G. Monte Carlo methods in statistical physics (Oxford university press, 1999)) with probability

min{1, exp(dS/T)} (3)

where dS is the score difference from the previous active set using scoring function (2), and T is an effective temperature, lowered by a factor of 10% between sweeps.

The coarse-graining stage described above preferably examines networks at a lower level of structure. The “coarse-graining” process is then optionally and preferably repeated on multiple levels of the network. In each such repetition the network is preferably simplified to contain fewer nodes and connections, which represent a new network on which the next iteration of the coarse-graining algorithm is then optionally performed. Additionally, in each such iteration each node (SIU) becomes more complicated as it contains at least one SIU from the set obtained in the previous coarse-graining iteration.

Therefore, the coarse graining process (creating a coarse-grain network) is preferably performed with a plurality of iterations and is more preferably repeated iteratively until a goal is reached. The goal optionally and preferably comprises reaching a threshold for a minimum size of the network. Alternatively, optionally and preferably the goal comprises obtaining a network lacking an optimal coarse graining reduction (in other words, a network for which performing another coarse-graining process would not yield a further reduction in network size).

It is important to note that networks having particular modularity and topology and that can be represented as a graph can be effectively coarse-grained. Such networks are preferably modular, in the sense that they preferably feature smaller (i.e. smaller than the network itself), recurring building blocks which may be used to build the network. Preferably, in the recurring building blocks there are fewer mixed nodes (nodes having multiple interconnections).

### EXAMPLE 7

### Coarse Graining of an Electronic Circuit

The electronic circuit studied was derived from the ISCAS89 benchmark set of sequential logic electronic circuits (F. Brglez, D. Bryan, K. Kozminski, Proc. IEEE Int. Symposium on Circuits and Systems, 1929-1934 (1989), R. F. Cancho, C. Janssen, R. V. Sole, Phys Rev E 64, 046119 (2001)). This circuit is a module used in a digital fractional multiplier (Nagle, H. T., Carrol, B. D. & Irwin, J. D. An Introduction to Computer Logic (Prentice Hall, Englewood Cliffs, 1975)) that can be viewed at several different levels.

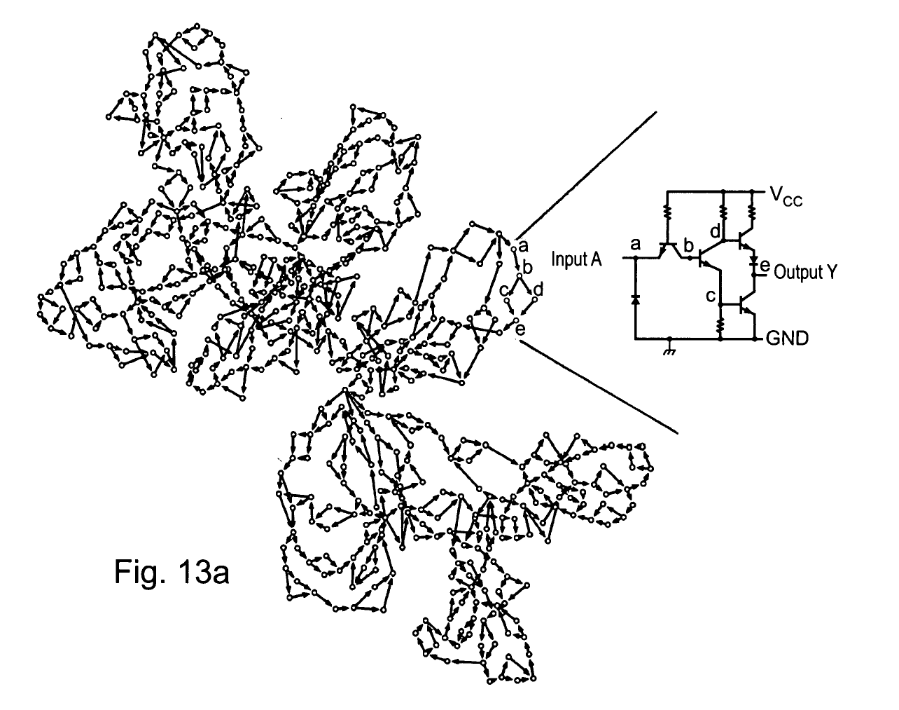

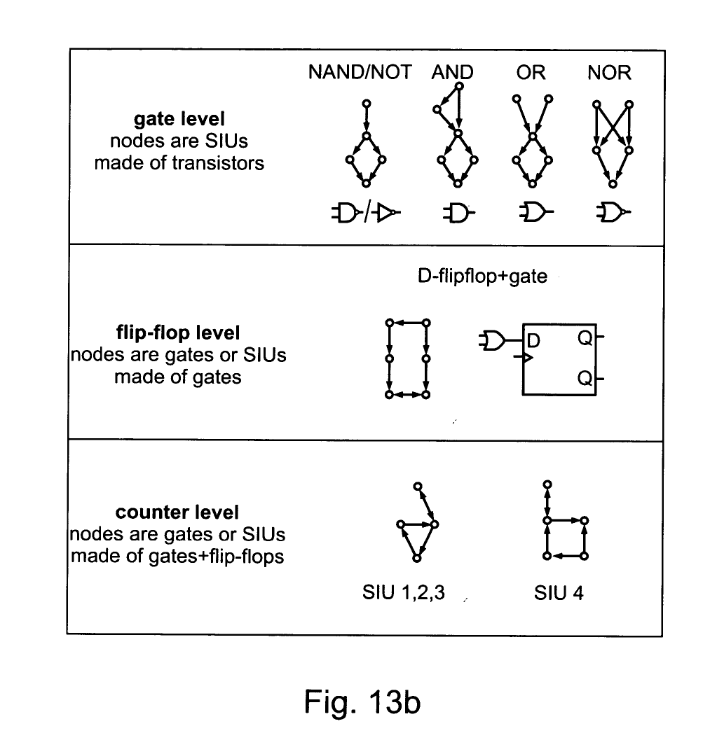

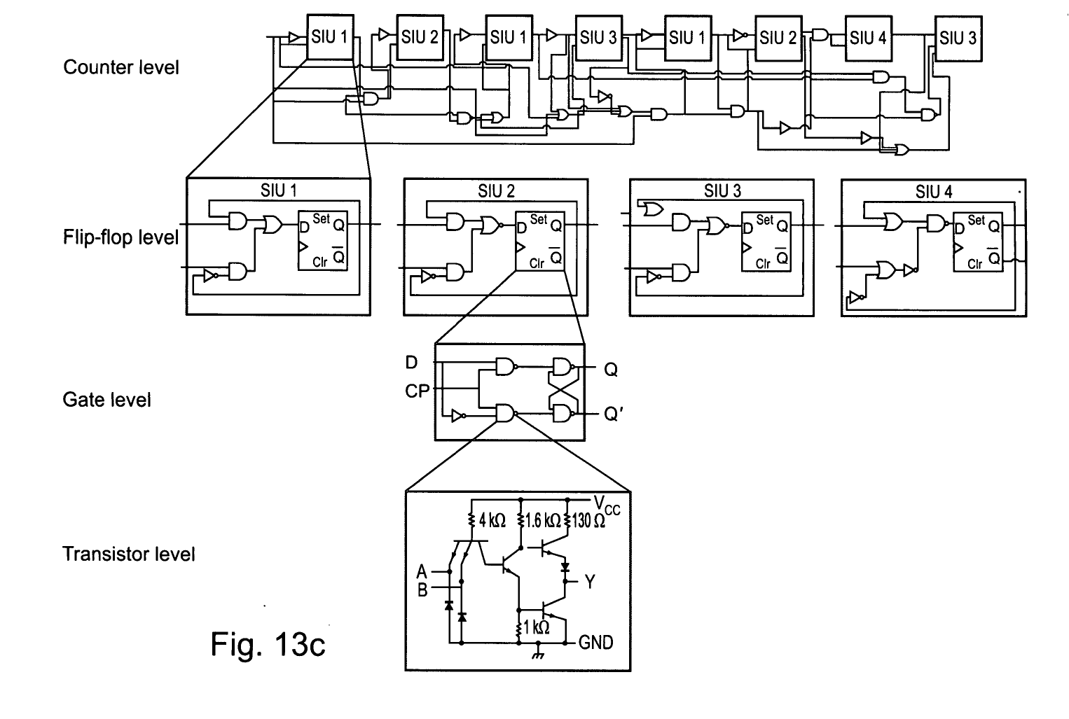

The transistor level description shown in FIG. 13A comprises a network with 516 nodes and 686 edges. In this map nodes are junctions between transistors, and edges represent wire connections. The highlighted section in the figure shows a sub-graph that represents the transistors that make up one NOT gate.

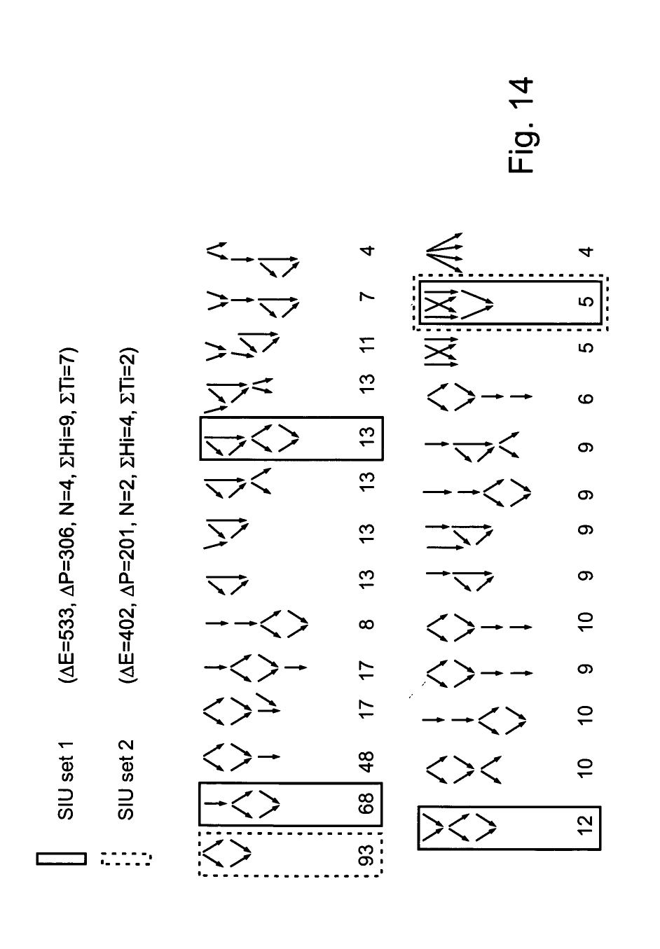

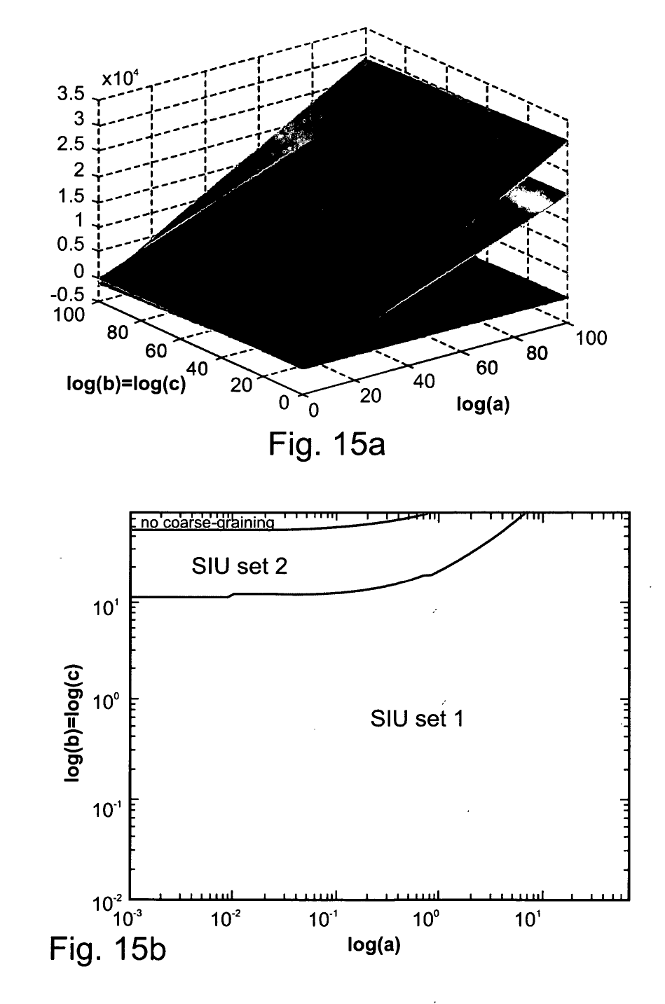

The network was analyzed with the coarse graining algorithm described in Example 6, enumerating as potential network motifs for the original analysis all sub-graphs of sizes 3-6 nodes. As shown in FIG. 14 for the present network four SIU types are obtained in the first level of coarse-graining. This solution is insensitive to the exact choice of optimization parameters, which can vary by several orders of magnitude, as shown in FIG. 15A. A second solution set, shown in FIG. 14 is obtained for a narrow range of parameters as presented in FIG. 15B. This solution has a smaller number of SIUs with less internal complexity, but which cover a smaller part of the original network. For high values of the parameters b and c, the best solution is obtained by not performing any coarse graining, as the penalty for any SIU is higher than the gain obtained by reducing the number of nodes and edges in the network.

FIG. 13B portrays the resulting SIUs for different coarse-graining levels of this network. Detection of SIUs in this network reveals several five or six node patterns as displayed. Strikingly, the detected SIU patterns correspond to the transistor implementation of the five basic logic gates AND, NAND, NOR, OR and NOT. A new network may be constructed, in which each of the nodes is one of these gates, represented by SIUs, containing 99 nodes and 153 edges in a coarse-grain “gate” level.

Running the same coarse-graining algorithm on the newly formed network results in one six node SIU, occurring eight times and corresponding to a D-Flip-Flop with an additional logic gate, as shown in FIG. 13B. The D-Flip-Flop is built out of four NAND gates and one NOT gate (Horowitz, P. & Hill, W. The Art of Electronics (Cambridge university press, Cambridge, 1989)) (FIG. 13C). The “flip-flop level” coarse-grained network formed by this procedure contains nodes that are either basic logic gates or flip-flops, and has 59 nodes and 97 edges.

Two types of SIUs shown in FIG. 13B are discovered when running the same procedure on the “flip flop level” coarse-grain network, corresponding to units of a digital counter. There are seven occurrences of a 3-node feedback loop and mutual edge, representing SIUs 1,2 and 3 in FIG. 13C and one occurrence of a 4-node feedback loop and mutual edge representing SIU4. The highest level coarse-grained network is constructed using these SIUs, in which each node is either a SIU or a basic logic gate. The resultant network has 42 nodes and 56 edges, and therefore has 12-fold fewer nodes and edges than the original transistor level network. The high-level network corresponds to a sequential connection of counter units, each of which halves the frequency of the binary stream obtained from the previous unit, and therefore describes an 8-bit counter (Nagle, H. T., Carrol, B. D. & Irwin, J. D. An Introduction to Computer Logic (Prentice Hall, Englewood Cliffs, 1975)), as was expected.

FIG. 13C portrays four levels of representation of this network. In the transistor level, nodes represent transistor junctions. In the gate level nodes are SIUs made of transistors, each representing a logic gate. In the flip-flop level, nodes are either gates or an SIU made of gates that corresponds to a D-type flip-flop. In the highest level each node is a gate or an SIU of gates or flip-flops that corresponds to a counter subunit.

This coarse-grained network displays a different set of network motifs or SIUs in each level of resolution, and is therefore ‘self dissimilar’ (Wolpert, D. H. & Macready, W. G. Self-Dissimilarity: An Empirical Observable Complexity Measure. In “Unifying Themes in Complex Systems, Y. Bar-Yam (Ed.), 626-643 (2000), Carlson, J. M. & Doyle, J. Complexity and robustness. PNAS 99 suppl 1, 2538-45 (2002)). This is in contrast with the view based on statistical mechanics which emphasizes self similarity of complex systems near phase transition points.

When analyzing other electronic circuits, other SIUs are found, including the XOR gate built of 4 NAND gates (not shown). Thus, the SIU approach can automatically detect favorite modules used by electronic engineers. Since the network comprises transistors which build the structure of these favorite modules, replacing the transistors with a node representing the module enables coarse graining of the network. As these modules appear often in the analyzed networks, they may be chosen as network-motifs and be included in an initial group of SIUs for the analysis in Example 6, and thus they are likely to be detected in the network.

### EXAMPLE 8

### SIU Finding in Protein Signaling Networks

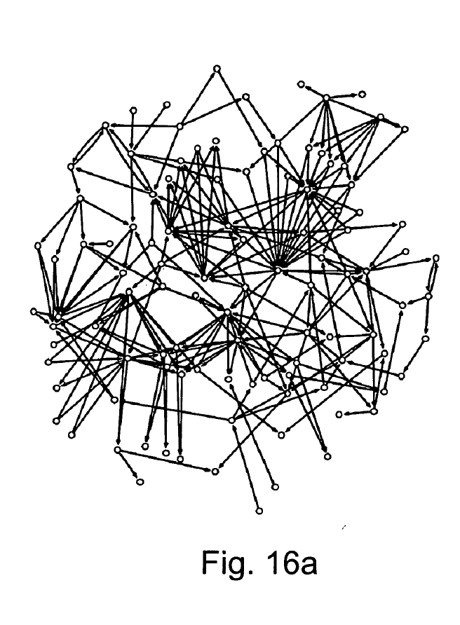

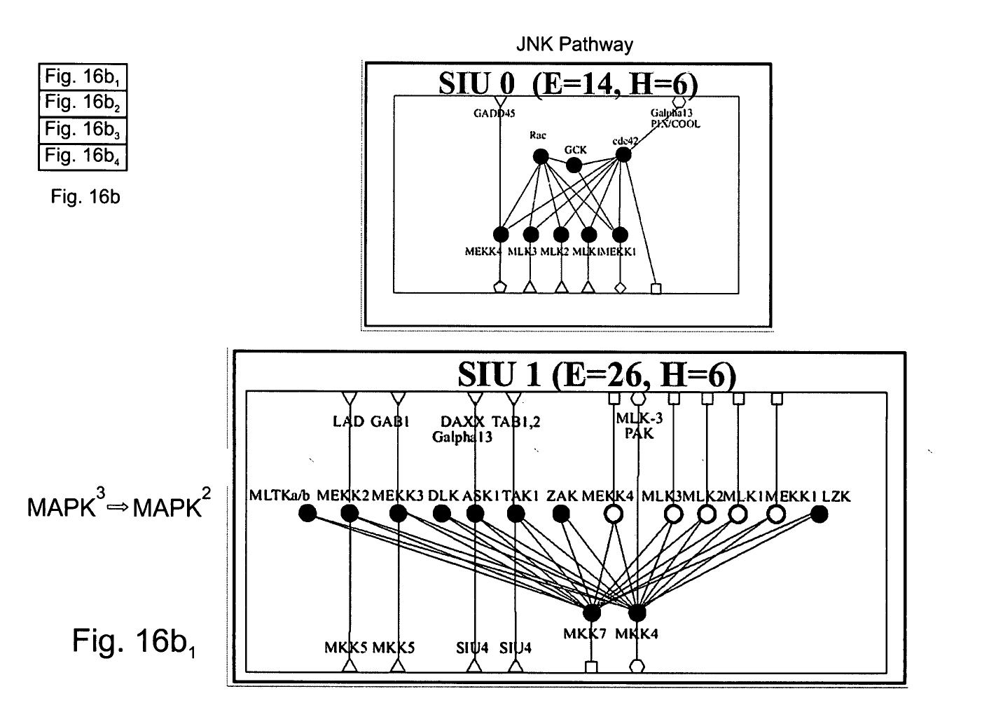

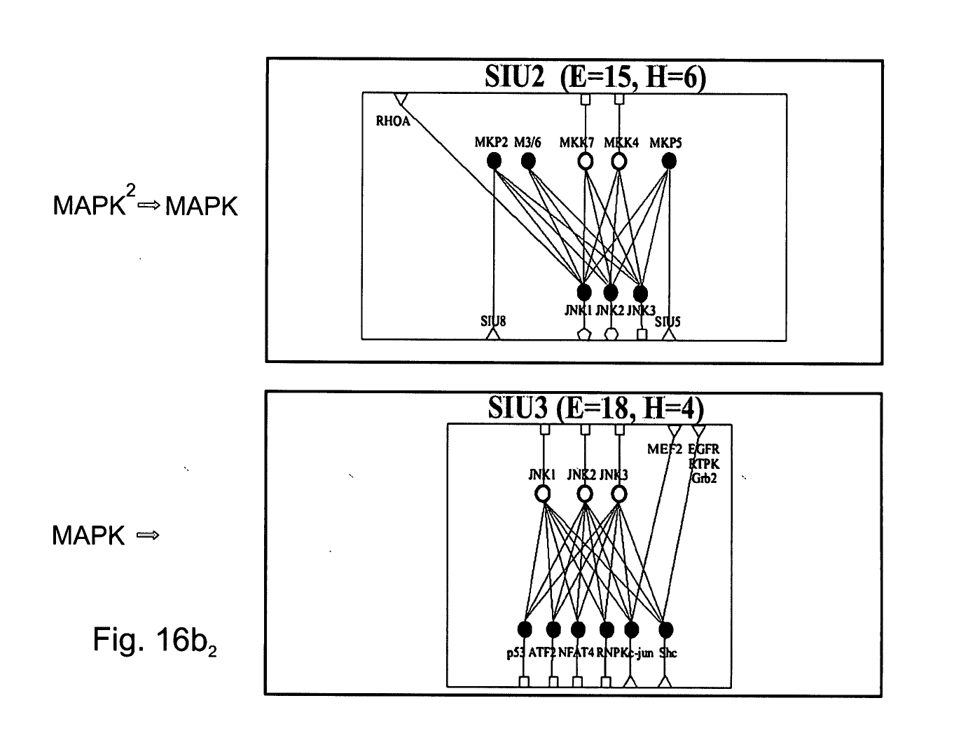

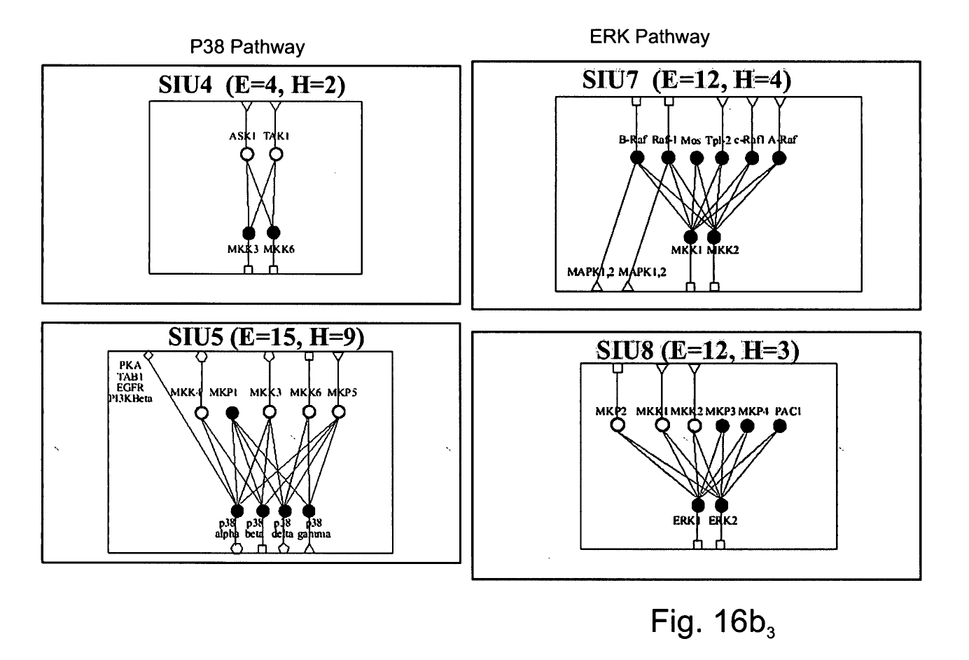

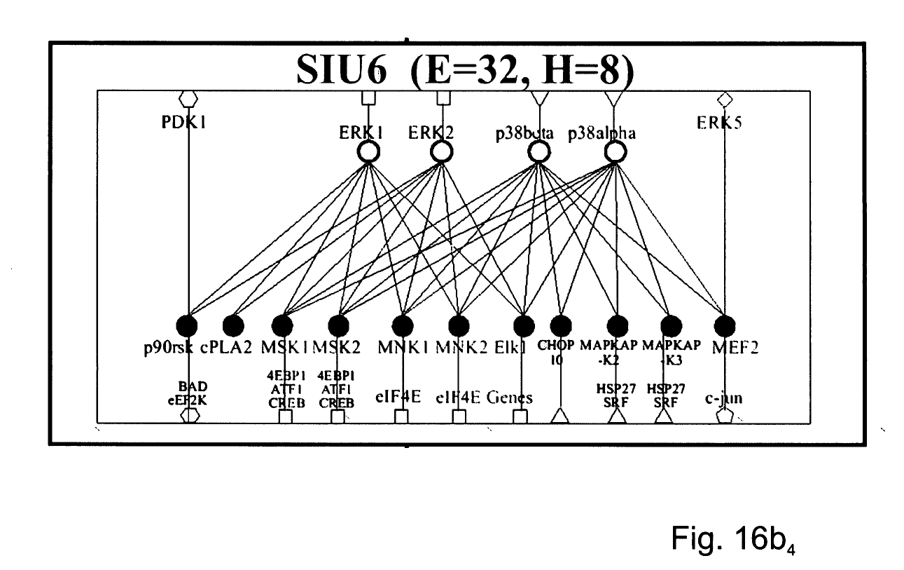

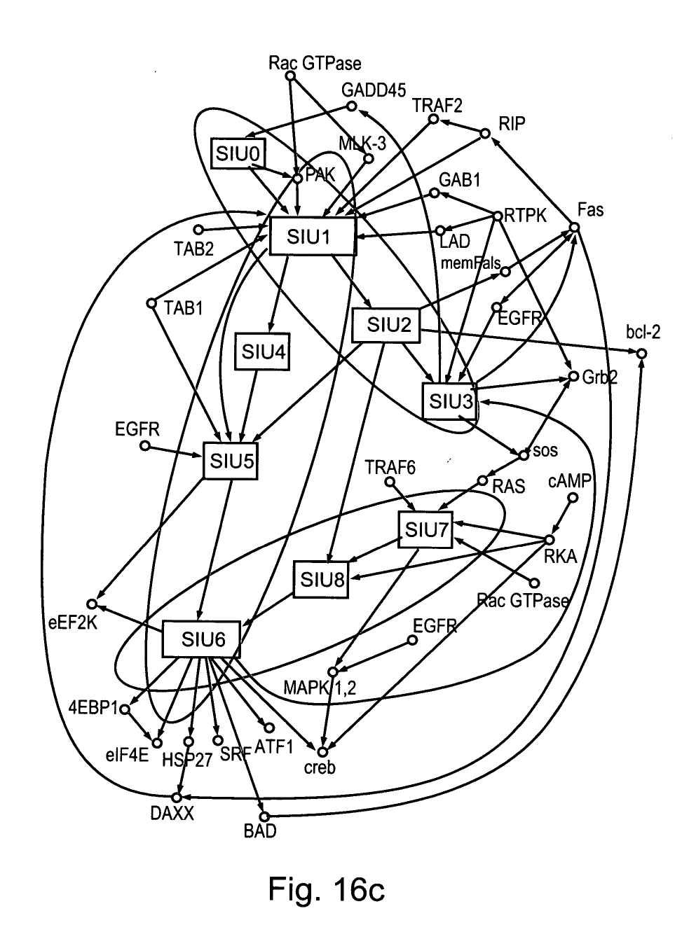

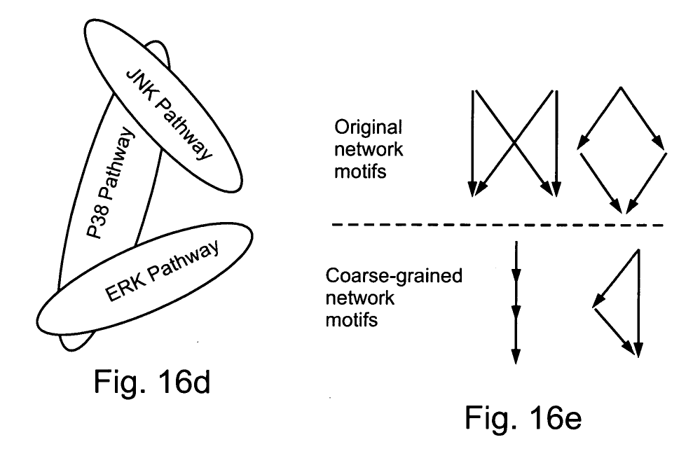

A database of human signal transduction pathways (Huang, C. Y. & Ferrell, J. E., Jr. Ultrasensitivity in the mitogen-activated protein kinase cascade. PNAS 93, 10078-83 (1996), Bhalla, U. S. & Iyengar, R. Emergent properties of networks of biological signaling pathways. Science 283, 381-7 (1999), Charette, S. J., Lavoie, J. N., Lambert, H. & Landry, J. Inhibition of Daxx-mediated apoptosis by heat shock protein 27. Mol Cell Biol 20, 7602-12 (2000), Levine, A. J. p53, the cellular gatekeeper for growth and division. Cell 88, 323-31 (1997), Pearson G. et al. Mitogen-activated protein (MAP) kinase pathways: regulation and physiological functions. Endocr Rev 22, 153-83 (2001), Kyriakis, J. M. & Avruch, J. Mammalian mitogen-activated protein kinase signal transduction pathways activated by stress and inflammation. Physiol Rev 81, 807-69 (2001)) based on the Signal Transduction Knowledge Environment (www.stke.org) was analyzed in this non-limiting Example. As can be seen in FIG. 16A, the dataset contains 94 proteins, and 209 directed interactions between them.

Initially, the algorithm of Example 1 was run on the dataset, resulting in a prominent network motif—the 4-node bi-fan (Milo R. et al. Network motifs: simple building blocks of complex networks. Science 298, 824-7 (2002)) (as described in greater detail above). Maximal generalizations of this sub-graph were detected, including larger sub-graphs obtained by duplicating one node of the four sub-graph nodes together with its connections (Kashtan, N., Itzkovitz, S., Milo, R. & Alon, U. Network motifs in biological networks: Roles and Generalizations. Submitted (2003)). Neighboring nodes of the resulting sub-graphs were added or removed and the coarse graining score was recalculated each time, according to the algorithm detailed in Example 6.

Nine SIUs were discovered when running the algorithm of Example 6, all sharing a common design consisting of a row of input nodes which send overlapping interactions to a row of output nodes, as shown in FIG. 16B. This type of structure allows hard wired combinatorial activation and inhibition of outputs. Since each output node receives input from a group of input nodes, and since there is a large number of input nodes, there can be many different combinations of inputs effecting different output nodes. In addition, the effect of the different input groups on a specific output node may differ, as some combinations will activate the output, and others will inhibit it, and thus the combinatorial effect on the output is achieved. A similar structure was found in transcription regulation networks as described in Example 2 above, and was nicknamed ‘dense overlapping regulons’ (Shen-Orr, S., Milo, R., Mangan, S. & Alon, U. Network motifs in the transcriptional regulation network of Escherichia coli. Nat Genet 31, 64-8 (2002)). However, some appearances of this structure are slightly different than others. For example, there are cases in which the input and output rows of an SIU represent protein from the same sub-family of proteins, like JNK1, JNK2, and JNK3 shown in SIU3 in FIG. 16B, and other cases in which proteins from different sub-families are represented in the input and output rows of an SIU, as in ERK and p38 found in SIU6 of the figure.

The original signaling network can be coarse-grained using the found SIUs (FIG. 16C), showing three major signaling channels (FIG. 16D). The three signaling channels shown correspond to the well studied ERK, JNK, and p38 MAP-Kinase cascades, which respond to stress signals and growth factors (Huang, C. Y. & Ferrell, J. E., Jr. Ultrasensitivity in the mitogen-activated protein kinase cascade. PNAS 93, 10078-83 (1996), Bhalla, U. S. & Iyengar, R. Emergent properties of networks of biological signaling pathways. Science 283, 381-7 (1999), Pearson G. et al. Mitogen-activated protein (MAP) kinase pathways: regulation and physiological functions. Endocr Rev 22, 153-83 (2001) Kyriakis, J. M. & Avruch, J. Mammalian mitogen-activated protein kinase signal transduction pathways activated by stress and inflammation. Physiol Rev 81, 807-69 (2001)). The JNK and p38 cascades intersect at SIU1 (of FIG. 16B) and p38 and ERK channels intersect at SIU6.

Each of the discovered channels contains three SIUs in a cascade. In each cascade, the top and bottom SIUs contain only positive (kinase) interactions, and the middle SIU contains both positive and negative (phosphatase) interactions. Feedback loops can be easily visualized in the resultant coarse-grained network, such a feedback from SIU1 through SIU6 HSP27 which is a protein involved in response to stress and heat-shock, and DAXX which is a transcription regulator, functional by way of protein-protein interactions (Charette, S. J., Lavoie, J. N., Lambert, H. & Landry, J. Inhibition of Daxx-mediated apoptosis by heat shock protein 27. Mol Cell Biol 20, 7602-12 (2000)), and the feedback from SIU0 through SIU3 (p53) and GADD45 which is involved in the regulation of growth and apoptosis, as well as being a mediator of activation of different stress responsive proteins, such as MAPKKK (Levine, A. J. p53, the cellular gatekeeper for growth and division. Cell 88, 323-31 (1997)).

The present approach allows a simplified coarse-grained view of this signaling network showing the major signaling channels, and specifies the recurring circuit elements (SIUs) that may characterize protein signaling pathways in other cellular systems and organisms.

Interestingly, the coarse-grained signaling network displays a different set of network motifs than the original network, with prominent cascades and more frequent feed-forward loops (described above). Therefore, similar to the electronic circuit network, the network is ‘self dissimilar’, displaying different structures at each level of resolution (Wolpert, D. H. & Macready, W. G. Self-Dissimilarity: An Empirical Observable Complexity Measure. In “Unifying Themes in Complex Systems, Y Bar-Yam (Ed.), 626-643 (2000), Carlson, J. M. & Doyle, J. Complexity and robustness. PNAS 99 suppl 1, 2538-45 (2002)). This is in contrast with the view based on statistical mechanics which emphasizes self similarity of complex systems near phase transition points. For example, when one magnifies a snowflake, it retains the same structure on different levels, which is self-similarity. By contrast, at each level of coarse-graining, the motifs have been shown to frequently change for a network such as those examined herein.

### CONCLUSIONS

None of the network motifs shared by the food webs matched the motifs found in the gene regulation networks or the World Wide Web. Only one of the food web consensus motifs also appeared in the neuronal network. Different motif sets were found in electronic circuits with different functions. This suggests that motifs can define broad classes of networks, each with specific types of elementary structures. The motifs reflect the underlying processes that generated each type of network. For example, food webs evolve to allow a flow of energy from the bottom to the top of food chains whereas gene regulation and neuron networks evolve to process information. It is interesting that information processing seems to give rise to significantly different structures than energy flow.

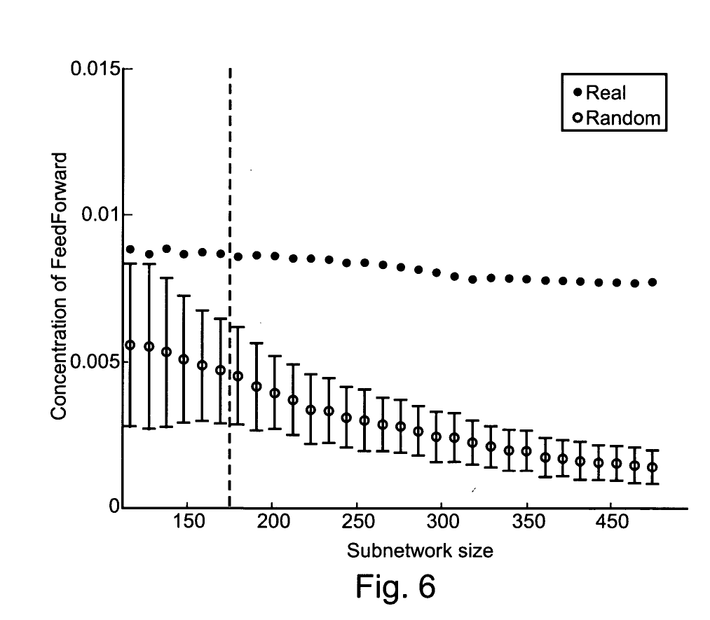

The statistical significance of the motifs was further characterized as a function of network size, by considering pieces of various sizes (sub-networks) of the full network. The concentration of motifs in the sub-networks is about the same as in the full network (FIG. 6). In contrast, the concentration of the corresponding subgraphs in the randomized versions of the sub-networks decreases sharply with size.

In analogy to statistical physics, the numbers of appearance of each motif in the real networks appears to be an extensive variable (that is, one that grows linearly with the network size). These variables are non-extensive in the randomized networks. The existence of such variables may qualitatively distinguish evolved or designed networks from random ones. The non-motif subgraphs are either extensive in both random and real networks or non-extensive in both. The constant concentration of the motifs in the real network should be contrasted to the sharp decrease in concentration found in randomized networks: in Erdos-Renyi randomized networks with a fixed connectivity, the concentration of a subgraph with n nodes and k edges scales with network size as C˜S^{n-k-1} (thus, C˜1/S for the feedforward loop of FIG. 6 where n=k=3). The sole exception in FIG. 10 is the 3-chain pattern in food webs where n=3 and k=2.

The decrease of the concentration C with randomized network size S shown in FIG. 6 qualitatively agrees with exact results on Erdos-Renyi random graphs (random graphs which preserve only the number of nodes and edges of the real network) in which C˜1/S. In general, the larger the network is, the more significant the motifs tend to become. This trend can also be seen in FIG. 10 by comparing networks of different sizes. The network motif detection algorithm appears to be effective even for rather small networks (on the order of a hundred edges). This is due to the fact that 3- or 4-node subgraphs occur in large numbers even in small networks. Furthermore, the present approach is not sensitive to data errors. For example, the sets of significant network motifs do not change in any of the networks upon addition, removal or rearrangement of 20% of the edges at random.

In information processing networks, the motifs may have specific functions as elementary computational circuits. More generally, they may be interpreted as structures that arise due to the special constraints under which the network has evolved. It is of value to detect and understand network motifs, in order to gain insight into their dynamical behavior and to define classes of networks and network homologies. The present approach can be readily generalized to any type of network including those with multiple ‘colors’ of edges or nodes.

The present invention may also optionally be used to analyze such “man-made” systems as a healthcare system, a traffic system or a business process, for example. Business processes are a description of how a particular company or other organization operates, and typically includes at least one manually performed action that is performed by a human worker.

It will be appreciated that the above descriptions are intended only to serve as examples, and that many other embodiments are possible within the spirit and the scope of the present invention.

### REFERENCES

1. Thieffry, D., Huerta, A. M., Perez-Rueda, E. & Collado-Vides, J. From specific gene regulation to genomic networks: a global analysis of transcriptional regulation in Escherichia coli. Bioessays 20, 433-40. (1998).

2. Bray, D. Protein molecules as computational elements in living cells. Nature 376, 307-12. (1995).

3. Kauffmnan, S. A. Metabolic stability and epigenesis in randomly constructed genetic nets. J Theor Biol 22, 437-67. (1969).

4. Savageau, M. & Neidhart, F. C. Regulation beyond the operon. in Eschrichia coli and Salmonella: Cellular and molecular biology (ed. Neidhart, F. C.) 1310-1324 (American Society for Microbiology, Washington D.C., 1996).

5. Rao, C. V. & Arkin, A. P. Control Motifs for Intracellular Regulatory Networks. Annual review of biomedical engineering 3, 391-419 (2001).

6. Barabasi, A. L. & Albert, R. Emergence of scaling in random networks. Science 286, 509-12. (1999).

7. Strogatz, S. H. Exploring complex networks. Nature 410, 268-76. (2001).

8. Hartwell, L. H., Hopfield, J. J., Leibler, S. & Murray, A. W. From molecular to modular cell biology. Nature 402, C47-52. (1999).

9. Branden, C. & Tooze, J. Introduction to protein structure, (Garland, N.Y., 1991).

10. Williams, R. & Martinez, N. Simple rules yield complex food webs. Nature 404, 180-183 (2000).

11. White, J., Southgate, E., Thomson, J. & Brenner, S. The structure of the nervous system of the nematode Caenorhabditis elegans. Phil. Trans. Roy. Soc. London Ser. B 314 (1986).

12. Podani, J. et al. Comparable system-level organization of Archaea and Eukaryotes. Nat Genet 13, 13 (2001).

13. Watts, D. & Strogatz, S. Collective dynamics of ‘small-world’ networks. Nature 393, 440-442 (1998).

14. Newman, M., Moore, C. & Watts, D. Mean-field solution of the small-world network model. Phys. Rev. Lett. 84, 3201-3204 (2000).

15. Jeong, H., Tombor, B., Albert, R., Oltvai, Z. N. & Barabasi, A. L. The large-scale organization of metabolic networks. Nature 407, 651-4. (2000).

16. Amaral, L., Scala, A., Barthelemy, M. & Stanley, H. Classes of small world networks. PNAS 97, 11149-11152 (2000).

17. Shen-Orr, S., Milo, R. & Alon, U. Network motifs in the transcriptional network of Escherichia coli. Submitted.

18. Newman, M., Strogatz, S. & Watts, D. Random graphs with arbitrary degree distribution and thier applications. Phys Rev E 64, 6118-6123 (2001).

19. Duda, R. O. & Hart, P. E. Pattern Classification and Scene Analysis, (Wiley, N.Y., 1973).

20. Kalir, S. et al. Ordering genes in a flagella pathway by analysis of expression kinetics from living bacteria. Science 292, 2080-3. (2001)

21. Costanzo, M. C. et al. YPD, PombePD and WormPD: model organism volumes of the BioKnowledge library, an integrated resource for protein information. Nucleic Acids Res 29, 75-9. (2001).

22. Perez-Rueda, E., Gralla, J. D. & Collado-Vides, J. Genomic position analyses and the transcription machinery. J Mol Biol 275, 165-70. (1998).

23. Salgado, H. et al. RegulonDB (version 3.2): transcriptional regulation and operon organization in Escherichia coli K-12. Nucleic Acids Res 29, 72-4. (2001).

24. Hengge-Aronis, R. Survival of hunger and stress: the role of rpoS in early stationary phase gene regulation in E. coli. Cell 72, 165-8. (1993).

25. Schleif, R. Regulation of the L-arabinose operon of Escherichia coli. Trends Genet 16, 559-65. (2000).

26. Yuh, C. H., Bolouri, H. & Davidson, E. H. Genomic cis-regulatory logic: experimental and computational analysis of a sea urchin gene. Science 279, 1896-902. (1998).

27. Durbin, R. PhD Thesis: Studies on the development and organization of the nervous system of Caenohabditis elegans. Cambridge University, 1-121 (1987).

28. Cohen, J., Briand, F. & Newman, C. Community Food Webs: Data and Theory (Springer, Berlin, 1990).

29. Martinez, N. Artifacts or attributes—effect of resolution on the little-rock lake food web. Ecological Monographs 61, 367-392 (1991).

30. Pimm, S., Lawton, J. & Cohen, J. Food web patterns and their consequences. Nature 350, 669-674 (1991).

31. Callaway, D., Hopcroft, J., Kleinberg, J., Newman, M. & Strogatz, S. Are randomly grown graphs really random? Phys. Rev. E 6404, 1902 (2001).

32. Newman, M. The structure of scientific collaboration networks. PNAS 98, 404-409 (2001).

33. Kashtan, N., Itzkovitz, S., Milo, R. & Alon, U. Network motifs in biological networks: Roles and Generalizations. Submitted (2003).

34. Kirkpatrick, S., Gelatt, C. & Vecchi, M. Optimization by simulated annealing. Science 220, 671-680 (1983).

35. Newman, M. & Barkema, G. Monte Carlo methods in statistical physics (Oxford university press, 1999).

36. Nagle, H. T., Carrol, B. D. & Irwin, J. D. An Introduction to Computer Logic (Prentice Hall, Englewood Cliffs, 1975).

37. Horowitz, P. & Hill, W. The Art of Electronics (Cambridge university press, Cambridge, 1989).

38. Wolpert, D. H. & Macready, W. G. Self-Dissimilarity: An Empirical Observable Complexity Measure. In “Unifying Themes in Complex Systems, Y. Bar-Yam (Ed.), 626-643 (2000).

39. Carlson, J. M. & Doyle, J. Complexity and robustness. PNAS 99 suppl 1, 2538-45 (2002).

40. Huang, C. Y. & Ferrell, J. E., Jr. Ultrasensitivity in the mitogen-activated protein kinase cascade. PNAS 93, 10078-83 (1996).

41. Bhalla, U. S. & Iyengar, R. Emergent properties of networks of biological signaling pathways. Science 283, 381-7 (1999).

42. Charette, S. J., Lavoie, J. N., Lambert, H. & Landry, J. Inhibition of Daxx-mediated apoptosis by heat shock protein 27. Mol Cell Biol 20, 7602-12 (2000).

43. Levine, A. J. p53, the cellular gatekeeper for growth and division. Cell 88, 323-31 (1997).

44. Pearson G. et al. Mitogen-activated protein (MAP) kinase pathways: regulation and physiological functions. Endocr Rev 22, 153-83 (2001).

45. Kyriakis, J. M. & Avruch, J. Mammalian mitogen-activated protein kinase signal transduction pathways activated by stress and inflammation. Physiol Rev 81, 807-69 (2001).

46. Milo R. et al. Network motifs: simple building blocks of complex networks. Science 298, 824-7 (2002).

47. Shen-Orr, S., Milo, R., Mangan, S. & Alon, U. Network motifs in the transcriptional regulation network of Escherichia coli. Nat Genet 31, 64-8 (2002).

7A. R. F. Cancho, C. Janssen, R. V. Sole, Phys Rev E 64, 046119 (2001).

4A. A. L. Barabasi, R. Albert, Science 286, 509-12. (1999).

25A. F. Brglez, D. Bryan, K. Kozminski, Proc. IEEE Int. Symposium on Circuits and Systems, 1929-1934 (1989).

What is claimed is:

1. A method for analyzing a system, the system being representable as a plurality of nodes connected by edges to form a graph, the method comprising:
analyzing the graph to form a plurality of sub-graphs, each sub-graph containing a plurality of nodes connected by at least one edge; and
analyzing said plurality of sub-graphs to detect a type of sub-graph occurring at a threshold frequency in the graph, said type of sub-graph forming a motif of the system.

2. The method of claim 1, wherein said analyzing said plurality of sub-graphs further comprises:
constructing a randomized graph;
comparing a frequency of appearance of said type of sub-graph in said randomized graph with a frequency of appearance of said type of sub-graph in the graph; and
if a difference between said frequency of appearance of said type of sub-graph in said randomized graph and said frequency of appearance of said type of sub-graph in the graph is significant, forming said motif with said type of sub-graph.

3. The method of claim 2, wherein said randomized graph has at least one feature similar to said network graph.

4. The method of claim 3, wherein a plurality of characteristics of said nodes of said randomized graph is identical to said plurality of said characteristics of said nodes of said network graph.

5. The method of claim 1, wherein a type of sub-graph is determined as having a particular set of said plurality of nodes and of said at least one edge.

6. The method of claim 1, wherein a type of sub-graph is determined according to an equivalence of a plurality of nodes and of at least one edge

7. The method of claim 1, wherein said analyzing the graph further comprises:
constructing a connectivity matrix for representing the graph, wherein each node is represented by an element of said connectivity matrix.

8. The method of claim 7, wherein said analyzing said graph further comprises:
examining each row i of said connectivity matrix;
within each row i, examining each element (i,j);
for each element (i,j), examining each connected element existing as a node in the graph; and
if a plurality of connected elements exist as nodes in the graph, repeating recursively for said plurality of connected elements.

9. The method of claim 7, wherein said analyzing said graph further comprises:
at least sampling said connectivity matrix to detect said type of sub-graph.

10. The method of claim 7, wherein said analyzing said graph further comprises:
exhaustively searching said connectivity matrix to detect said type of sub-graph.

11. The method of claim 7, wherein said analyzing said graph further comprises:
constructing a plurality of connectivity matrices, wherein each connectivity matrix represents a different discrete value in time for at least one edge between a plurality of nodes of the graph.

12. The method of claim 1, wherein the system comprises a gene transcription regulatory network.

13. The method of claim 1, wherein the system comprises an ecological food web.

14. The method of claim 1, wherein the system comprises a plurality of connected neurons.

15. The method of claim 1, wherein the system comprises at least one of a computer network, and a software program.

16. The method of claim 15, wherein said computer network is the World Wide Web.

17. The method of claim 1, wherein the system comprises an electronic circuit.

18. A method for analyzing a system, the system comprising a plurality of components, the method comprising:
constructing a connectivity matrix for representing the components of the system, said connectivity matrix comprising a plurality of elements, wherein a value for each element represents at least one characteristic of a relationship between a plurality of components; and
examining at least a portion of said connectivity matrix for analyzing the system.

19. The method of claim 18, wherein a network motif is detected after examining said at least a portion of said connectivity matrix.

20. The method of claim 19, wherein said at least a portion of said connectivity matrix is examined by analyzing a connection between a plurality of n elements, said connection being analyzed by examining a sub-matrix of n×n elements of said connectivity matrix.

21. The method of claim 20, wherein an element (i,j) of said connectivity matrix equals one if a first component j has a connection to a second component i, and wherein otherwise said element is equal to zero.

22. The method of claim 21, wherein a plurality of submatrices is detected by recursively searching for nonzero elements (i,j), and scanning row i and column j for non-zero elements.

23. The method of claim 21, wherein a search is performed for identical rows of said connectivity matrix for detecting a “fan-out”, wherein a plurality of the components of the system is related to a single component.

24. The method of claim 21, wherein the system is a gene transcription regulatory network, such that said element (i,j) is equal to one if operon j encodes for a transcription factor that transcriptionally regulates operon i and is equal to zero otherwise.

25. The method of claim 18, further comprising:
locating a gate array of a plurality of components of the system according to a distance between components belonging to said group.

26. The method of claim 25, wherein said distance is determined according to a distance measure, said distance measure being selected according to at least one characteristic of the system.

27. The method of claim 18, further comprising:
detecting at least a portion of the system operating at a lower efficiency than at least a second portion of the system.

28. The method of claim 18, wherein the system comprises a plurality of dynamic processes, such that analyzing the system includes analyzing said dynamic processes.

29. The method of claim 18, wherein the system comprises a healthcare system, a traffic system or a business process.

30. A computer software program, operative to analyze a system, the system being representable as a plurality of nodes connected by edges to form a graph, the program being capable of at least performing the processes of:
analyzing the graph to form a plurality of sub-graphs, each sub-graph containing a plurality of nodes connected by at least one edge; and
analyzing said plurality of sub-graphs to detect a type of sub-graph occurring at a threshold frequency in the graph, said type of sub-graph forming a motif of the system.

31. A method for analyzing a network, the network containing a plurality of sub-components, comprising selecting at least one sub-component according to a simplicity measure.

32. The method of claim 31 further comprising analyzing said selected at least one sub-component for determining relationship between said sub-component and the network.

33. The method of claim 31, wherein said simplicity measure comprises finding a minimum number of Structurally Independent Units (SIUs).

34. The method of claim 33, wherein said SIUs have a minimal optimized number of mixed nodes.

35. The method of claim 33, wherein said simplicity measure comprises counting the ports for each said SIU according to the function H=I+O+2M where I is the number of input nodes, O is the number of output nodes, and M is the number of mixed nodes.

36. The method of claim 31, wherein said selecting at least one sub-component according to said simplicity measure further comprises finding a maximum of a scoring function.

37. The method of claim 36, wherein said finding said maximum comprises applying a combinatorial optimization process to said scoring function.

38. The method of claim 37, wherein said combinatorial optimization process comprises a simulated annealing process.

39. The method of claim 38, wherein said applying said simulated annealing further comprises determining the probability that a less maximal result is accepted during said simulated annealing process, according to a Metropolis Monte-Carlo procedure.

40. The method of claim 31, wherein said sub-components are sub-graphs.

41. The method of claim 32, wherein said analyzing said sub-components further comprises:
selecting a plurality of sub-components; and
creating a dictionary of said selected sub-components.

42. The method of claim 31, wherein said selecting said sub-components further comprises minimizing a number of selected sub-components.

43. The method of claim 32, wherein said analyzing said sub-components further comprises:
creating a coarse-grain network of said system to obtain a plurality of sub-components; and
repeating said creating said coarse-grain network at least once.

44. The method of claim 43, wherein said repeating said creating said coarse-grain network comprises performing said repeating iteratively until a goal is reached.

45. The method of claim 44, wherein said goal comprises reaching a threshold for a minimum size of the network.

46. The method of claim 44, wherein said goal comprises obtaining a network lacking an optimal coarse graining reduction.

47. The method of claim 31, wherein said network comprises an electronic circuit.

48. The method of claim 31, wherein said network comprises a protein signaling pathway.

49. The method of claim 48, wherein said protein signaling pathway is human.

50. A method for analyzing a system, the system being representable as a plurality of nodes connected by edges to form a complex network, the method comprising:
analyzing said system to detect a plurality of types of sub-graphs occurring at a threshold frequency in the graph, each said type of sub-graph forming a network motif of the system, said network motifs forming a plurality of sub-components;
selecting a plurality of sub-components from said detected plurality of network motifs, each sub-component containing at least one node, according to a simplicity measure; and
applying a maximizing function to select one or more of said sub-components.

51. The method of claim 50, wherein said selecting said plurality of sub-components further comprises partitioning said selected sub-components according to a binary measure.

52. The method of claim 51, wherein said partitioning said sub-components further comprises assigning a spin variable to each said sub-component.

53. The method of claim 50, wherein said maximizing function further comprises applying simulated annealing.

54. A method for analyzing a network to obtain a set of a plurality of simpler sub-components, the method comprising iteratively applying a coarse-graining method to the network to obtain a plurality of sub-components.

55. The method of claim 54, wherein in each said iteration said selected sub-components contain at least one sub-component selected in the previous iteration.

56. The method of claim 54, wherein said set of sub-components is chosen according to a simplicity measure for reducing the number of connections of said sub-components to other components of the network.

57. The method of claim 56, wherein said reducing the number of connections comprises maximizing the scoring function
dE+a−dP−bΣᵢ₋₁^{N}Hi−cΣᵢ₋₁^{N}Ti
where dE is the difference between the number of edges in the original network and in the coarse-grained network, dP is the difference between the number of nodes (ports) in the original network and in the coarse-grained network, N is the number of different SIUs, Hᵢ is a simplicity measure for SIUᵢ, and Tᵢ is the number of internal nodes in SIUᵢ

58. The method of claim 54, wherein said sub-components occur at a threshold frequency in the graph, which is significantly higher than the occurrence of said sub-components in a randomized graph.
